(19) United States
(12) Patent Application Publication
(10) Pub. No.: US 2026/0163659 A1
(43) Pub. Date: Jun. 11, 2026

(54) METHOD AND APPARATUS FOR IMPROVING UPLINK CAPACITY IN NON TERRESTRIAL NETWORK

(71) Applicant: Electronics and Telecommunications Research Institute, Daejeon (KR)

(72) Inventor: Hee Wook KIM, Daejeon (KR)

(21) Appl. No.: 19/405,237

(22) Filed: Dec. 1, 2025

(30) Foreign Application Priority Data
Dec. 2, 2024 (KR) 10-2024-0176527
Feb. 14, 2025 (KR) 10-2025-0019618
Mar. 26, 2025 (KR) 10-2025-0039108
Nov. 14, 2025 (KR) 10-2025-0172852

(51) Int. Cl. H04B 17/318; H04L 5/00

(52) U.S. Cl. CPC H04B 17/318; H04L 5/0048

(57) ABSTRACT

A method of a terminal may comprise: receiving, from a base station, information on at least one resource for transmission of a message 3 (Msg3), the at least one resource being classified according to coverage enhancement (CE) levels; determining a first CE level based on a received signal strength; determining a target resource for transmission of the Msg3 in a resource corresponding to the determined first CE level among the at least one resource; and transmitting the Msg3 to the base station using the determined target resource.

### CROSS-REFERENCE TO RELATED APPLICATIONS

This application claims priority to Korean Patent Applications No. 10-2024-0176527, filed on Dec. 2, 2024, No. 10-2025-0019618, filed on Feb. 14, 2025, No. 10-2025-0039108, filed on Mar. 26, 2025, and No. 10-2025-0172852, filed on Nov. 14, 2025, with the Korean Intellectual Property Office (KIPO), the entire contents of which are hereby incorporated by reference.

### BACKGROUND

### 1. Technical Field

The present disclosure relates to an uplink capacity improvement technique in a non-terrestrial network (NTN), and more particularly, to a technique for improving uplink capacity by applying a diversity slotted ALOHA scheme to contention-based early data transmission.

### 2. Related Art

To cope with the rapidly increasing amount of wireless data, communication networks that use frequency bands (e.g. frequency bands above 6 GHZ) higher than those of Long Term Evolution (LTE) (or, LTE-A) (e.g. frequency bands below 6 GHZ), such as New Radio (NR) communication networks or 6G (sixth-generation) communication networks, are being considered. The NR communication network may support not only frequency bands below 6 GHz but also frequency bands above 6 GHz, and may support various communication services and scenarios compared to the LTE communication networks. For example, usage scenarios of the NR communication networks may include enhanced Mobile Broadband (eMBB), Ultra Reliable Low Latency Communication (URLLC), and massive Machine Type Communication (mMTC).

The NR communication network may provide communication services to terminals located on the ground (terrestrial). Recently, demand has been increasing for communication services not only for ground-based terminals but also for terminals located in non-terrestrial environments, such as airplanes, drones, and satellites. To address this, technologies for non-terrestrial networks (NTNs) are being discussed. The non-terrestrial network may be implemented based on NR technology. For example, communication between a satellite and a communication node located on the ground, or between communication nodes located in non-terrestrial environments (e.g. airplanes, drones), may be performed based on NR technology. In a non-terrestrial network, a satellite may serve as a base station in the NR communication network.

Meanwhile, the NTN may require increasingly more demands in order to support efficient data communication of various user equipments (UEs). A message transmission method that efficiently uses limited resources in the NTN may be one of important challenges. However, an existing message transmission method may increase a collision probability and may have a limitation of consuming excessive resources during initial configuration.

### SUMMARY

The present disclosure for resolving the above-described problems is directed to providing an uplink capacity improvement method and apparatus in a non-terrestrial network (NTN) for improving uplink capacity by applying a diversity slotted ALOHA scheme to contention-based early data transmission.

According to a first exemplary embodiment of the present disclosure, a method of a terminal may comprise: receiving, from a base station, information on at least one resource group for transmission of a message 3 (Msg3), the at least one resource being classified according to coverage enhancement (CE) levels; determining a first CE level based on a received signal strength; determining a target resource for transmission of the Msg3 in a resource corresponding to the determined first CE level among the at least one resource; and transmitting the Msg3 to the base station using the determined target resource.

The method may further comprise: transmitting, to the base station, a replica message identical to the Msg3 within a predetermined time window.

The method may further comprise: receiving, from the base station, a message 4 (Msg4) in response to the Msg3; determining whether transmission of the Msg3 is successful based on the received Msg4; and retransmitting the Msg3 based on determining that the transmission of the Msg3 fails.

The determining of whether the transmission of the Msg3 is successful comprises: acquiring a contention resolution identifier from the Msg4; and based on whether the contention resolution identifier matches a portion of bits of a Common Control Channel (CCCH) Service Data Unit (SDU) transmitted in the Msg3, determining whether the transmission of the Msg3 is successful.

The retransmitting of the Msg3 may comprise: reselecting a target resource after a backoff period; and retransmitting the Msg3 using the reselected target resource.

The determining of the first CE level may comprise: receiving a reference signal from the base station; measuring the received signal strength of the reference signal; and determining the first CE level based on the measured received signal strength.

The determining of the target resource may comprise: determining a size of data to be transmitted; determining whether the size of the data is equal to or less than a predetermined transport block size; and determining the target resource based on determining that the size of the data is equal to or less than the predetermined transport block size.

The method may further comprise: determining a size of data to be transmitted; determining whether the size of the data exceeds a predetermined transport block size; and initiating a radio resource control (RRC) connection request procedure based on determining that the size of the data exceeds the predetermined transport block size.

The information on the at least one resource may include, for each CE level, at least one of: information on resource(s), a number of repetitions, or a window.

According to a second exemplary embodiment of the present disclosure, a method of a base station may comprise: configuring at least one resource for transmission of a message 3 (Msg3), the at least one resource being classified according to coverage enhancement (CE) levels; transmitting, to a terminal, information on the at least one resource; receiving a Msg3 from the terminal through a target resource selected within a resource determined according to a CE level for the terminal among the at least one resource; and transmitting, to the terminal, a message 4 (Msg4) in response to the Msg3.

The transmitting of the information on the at least one resource to the terminal may comprise: generating a system information block including the information on the at least one resource; and broadcasting the system information block toward the terminal.

The Msg4 includes a contention resolution identity configured to allow the terminal to identify the Msg4 as a response to the Msg3.

The Msg4 includes at least one of: a first radio network temporary identifier (RNTI) for identifying Msg3 transmission of an individual terminal, or a second RNTI for identifying the terminal.

The first RNTI is generated based on a result of performing a modulo operation on a system frame number (SFN) with respect to a length of a contention resolution window.

According to a third exemplary embodiment of the present disclosure, a terminal may comprise at least one processor, wherein the at least one processor may cause the terminal to perform: receiving, from a base station, information on at least one resource for transmission of a message 3 (Msg3), the at least one resource being classified according to coverage enhancement (CE) levels; determining a first CE level based on a received signal strength; determining a target resource for transmission of the Msg3 in a resource corresponding to the determined first CE level among the at least one resource; and transmitting the Msg3 to the base station using the determined target resource.

The at least one processor may further cause the terminal to perform: transmitting, to the base station, a replica message identical to the Msg3 within a predetermined time window.

The at least one processor may further cause the terminal to perform: receiving, from the base station, a message 4 (Msg4) in response to the Msg3; determining whether transmission of the Msg3 is successful based on the received Msg4; and retransmitting the Msg3 based on determining that the transmission of the Msg3 fails.

In the determining of the first CE level, the at least one processor may cause the terminal to perform: receiving a reference signal from the base station; measuring the received signal strength of the reference signal; and determining the first CE level based on the measured received signal strength.

In the determining of the target resource, the at least one processor may cause the terminal to perform: determining a size of data to be transmitted; determining whether the size of the data is equal to or less than a predetermined transport block size; and determining the target resource based on determining that the size of the data is equal to or less than the predetermined transport block size.

The at least one processor may further cause the terminal to perform: determining a size of data to be transmitted; determining whether the size of the data exceeds a predetermined transport block size; and initiating a radio resource control (RRC) connection request procedure based on determining that the size of the data exceeds the predetermined transport block size.

According to the present disclosure, an NTN may apply a diversity slotted ALOHA scheme to contention-based early data transmission so that a plurality of UEs may share identical resources, and uplink capacity may be increased. In addition, the NTN may apply the diversity slotted ALOHA scheme to contention-based early data transmission to minimize data transmission delay and collisions, and to maximize utilization of network resources.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a sequence chart illustrating exemplary embodiments of an early data transmission method.

FIG. 5 is a sequence chart illustrating exemplary embodiments of a transmission method based on a preconfigured uplink resource.

FIG. 6 is a sequence chart illustrating exemplary embodiments of a method for improving uplink capacity in a non-terrestrial network.

FIG. 7 is a flowchart illustrating exemplary embodiments of a method of transmitting message 3 of a terminal.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The 6G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks (e.g. 4G communication network, 5G communication network, and/or 6G communication network). Here, the communication network may be used in the same sense as the communication system.

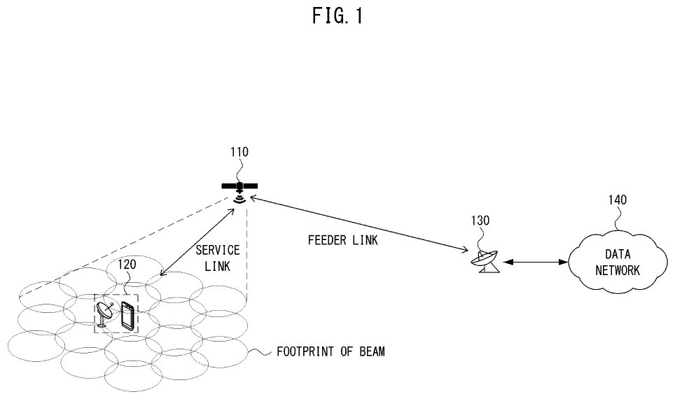

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

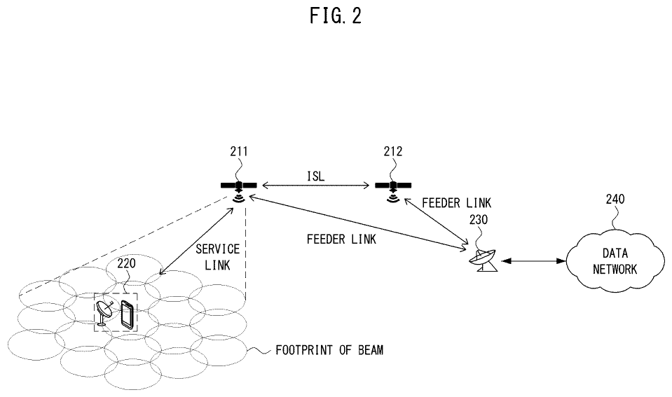

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a “core network” between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

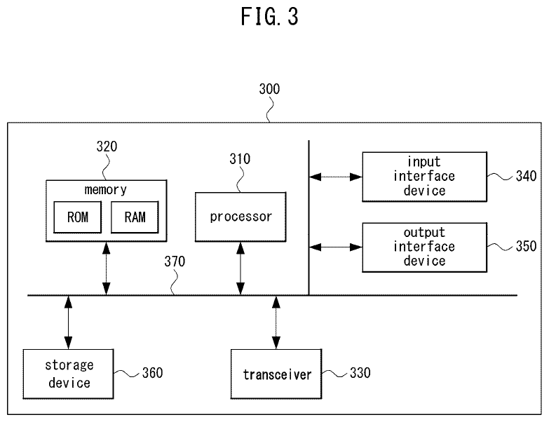

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum (service link) | <6 GHz (e.g. 2 GHz) | |
| | >6 GHz (e.g. DL 20 GHz, UL 30 GHz) | |
| Maximum channel bandwidth | 30 MHz for band <6 GHz | |
| capability | 1 GHz for band >6 GHz | |
| (service link) | | |
| Maximum distance between | 40,581 km | 1,932 km (altitude of 600 km) |
| satellite and communication | | 3,131 km (altitude of 1,200 km) |
| node (e.g. UE) at the minimum | | |
| elevation angle | | |
| Maximum round trip delay | Scenario A: 541.46 ms (service | Scenario C: (transparent |
| (RTD) | and feeder links) | payload: service and feeder |
| (only propagation delay) | Scenario B: 270.73 ms (only | links) |
| | service link) | −5.77 ms (altitude of 60 0 km) |
| | | −41.77 ms (altitude of 1,200 |
| | | km) |
| | | Scenario D: (regenerative |
| | | payload: only service link) |
| | | −12.89 ms (altitude of 600 km) |
| | | −20.89 ms (altitude of 1,200 |
| | | km) |
| Maximum differential delay | 10.3 ms | 3.12 ms (altitude of 600 km) |
| within a cell | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | Scenario D1-2 |
|---|---|---|---|---|
| Satellite altitude | 35,786 km | | 600 km | |
| Maximum RTD in a radio | 541.75 ms | 270.57 ms | 28.41 ms | 12.88 ms |
| interface between base | (worst case) | | | |
| station and UE | | | | |
| Minimum RTD in a radio | 477.14 ms | 238.57 ms | 8 ms | 4 ms |
| interface between base | | | | |
| station and UE | | | | |

Hereinafter, methods of improving uplink capacity in a non-terrestrial network in a communication system will be described. Even when a method performed in a first communication node (e.g. transmission or reception of a signal) among communication nodes is described, a second communication node corresponding thereto may perform a method corresponding to the method performed in the first communication node (e.g. reception or transmission of the signal). In other words, when an operation of a terminal is described, a base station corresponding thereto may perform an operation corresponding to the operation of the terminal. Conversely, when an operation of a base station is described, a terminal corresponding thereto may perform an operation corresponding to the operation of the base station.

A non-terrestrial network (NTN) may support various internet of things (IoT) devices. The non-terrestrial network may require increasing demands in order to efficiently support data communication of various user equipments (UEs) including the IoT devices. In the non-terrestrial network supporting IoT devices, a message transmission method that efficiently uses limited resources may be one of important challenges. In particular, radio resource allocation and contention resolution based on a message 3 (Msg3) may play an important role in improving data transmission efficiency.

However, an existing message transmission method may increase a collision probability and may have a limitation of consuming excessive resources during initial configuration. For example, a slotted ALOHA scheme for Msg3 transmission may increase the collision probability. An early data transmission (EDT) scheme for Msg3 transmission may cause a large consumption of initial configuration resources.

To address such problems and to maximize uplink capacity, the present disclosure proposes an uplink capacity improvement method that combines a contention-based message 3 (CB-Msg3) mechanism, a diversity slotted ALOHA (DSA) scheme, and an orthogonal cover code (OCC) technique. The uplink capacity improvement method proposed in the present disclosure may allow multiple UEs to share the same resource. In addition, the uplink capacity improvement method proposed in the present disclosure may minimize data transmission delay and collisions and may maximize network resource utilization.

Meanwhile, the DSA scheme may reduce the collision probability and may increase network resource activity. However, the DSA scheme may be difficult to satisfy particular requirements of the non-terrestrial network (e.g. long round trip time (RTT), limited resources, or massive terminal access). Accordingly, an improved DSA scheme suitable for the non-terrestrial network environment may be required. The improved DSA scheme according to such needs may be compatible with technical specifications of the non-terrestrial network and may minimize influence on the technical specifications. In addition, the improved DSA scheme may be optimized for transmission of a contention-based message 3.

The present disclosure is intended to solve the problems of the above-described related art, and has an object to provide an apparatus and a method for improving uplink capacity for an IoT NTN through contention-based early data transmission, which can simultaneously achieve uplink capacity increase and collision resolution by combining the CB-Msg3 mechanism and the DSA scheme.

The apparatus and method for improving uplink capacity of the present disclosure may simultaneously achieve uplink capacity increase and collision resolution by combining the CB-Msg3 mechanism and the DSA scheme. The apparatus and method for improving uplink capacity of the present disclosure can solve problems of the slotted ALOHA scheme having a high collision probability and an excessive resource consumption issue in an initial stage of the EDT) scheme through DSA-based CB-Msg3 transmission, can increase uplink capacity, and can resolve collisions.

According to an exemplary embodiment of the present disclosure, when terminals transmit CB-Msg3s using orthogonal cover codes (OCCs), a network may allow different OCCs to be used and may allow the same resource to be shared. In contrast, when terminals transmit CB-Msg3s using OCCs, the network may allow independent different resources to be used at the respective terminal. In addition, the network may define a reference signal received power (RSRP) range that is required to be satisfied for transmitting a CB-Msg3 using OCC in order to control a power imbalance. Such an approach may effectively manage a power imbalance among multiple terminals using OCC and may increase transmission success probability.

According to an exemplary embodiment of the present disclosure, a terminal may perform one contention-based early data transmission (CB-EDT) procedure at a specific time and may not perform multiple CB-EDT procedures simultaneously. Accordingly, the device may efficiently use network resources and may simplify the procedure.

According to an exemplary embodiment of the present disclosure, the network may apply a preconfigured uplink resource (PUR) configuration as a baseline of signal design, and may use a narrowband physical random access channel (NPRACH) configuration to share with a narrowband IoT physical uplink shared channel ((N) PUSCH) configuration. Some parameters may be included in a new CB-EDT configuration, and a new information element (IE), namely CBEDT-ConfigSIB-NB, may be considered to configure a CB-EDT function to support the configuration.

Therefore, the present disclosure efficiently supports a CB-EDT procedure based on the PUR and NPRACH configuration, and may improve configuration flexibility for early data transmission and resource utilization efficiency in the IoT-supported NTN environment through the definition of the new information element. Such a configuration scheme may enable efficient implementation of the CB-EDT function while maintaining compatibility with existing procedures.

The 3rd Generation Partnership Project (3GPP) defined a narrowband IoT (NB-IoT) standard to allow IoT communications for objects with low power consumption at a long distance. The NB-IoT standard adopted a method of transmitting and receiving data on a control plane and a method of simplifying an LTE signaling procedure. A terminal may not perform a radio channel connection procedure with a base station, and may transmit data to the base station by including the data in a radio resource control (RRC) early data request message. In this case, the terminal may be temporarily connected to the base station. The base station may receive the RRC early data request message including the data from the terminal. After transmitting the data to a 5G core network, the terminal may release the temporary connection and may minimize power consumption of the terminal.

The PUR scheme defined in 3GPP NB-IoT release 16 may be a method that allows a terminal to transmit a small amount of data without performing a random access procedure compared to an EDT procedure. The PUR may be configured by the terminal receiving PUR configuration information from the base station before transitioning to an idle state. Alternatively, the PUR may be configured by the terminal requesting PUR configuration from the base station.

The PUR configuration information may include a preconfigured uplink resource-radio network temporary identifier (PUR-RNTI), a preconfigured uplink resource-physical uplink control channel configuration (PUR-PUCCH-Config), and a preconfigured uplink resource-physical uplink shared channel configuration (PUR-PUSCH-Config). The PUR configuration information may include configuration of uplink radio resources for the terminal to transmit data to the base station. An NB-IoT terminal may transmit data to the base station on a control plane using the PUR configuration. The base station may receive data transmitted using the PUR configuration on the control plane. The terminal may transmit data to the base station using the PUR configuration information before entering the idle state. The base station may receive data transmitted by the terminal using the PUR configuration information before the terminal enters the idle state.

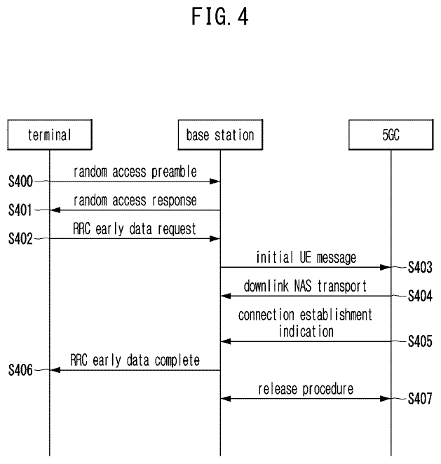

FIG. 4 is a sequence chart illustrating exemplary embodiments of an early data transmission method.

Referring to FIG. 4, the terminal may transmit a random access preamble to the base station for uplink synchronization acquisition, timing adjustment, and temporary identifier assignment (S400). The base station may receive the random access preamble from the terminal. The base station may transmit a random access response (RAR) message to the terminal (S401). The terminal may receive the RAR message from the base station.

The terminal may transmit an RRC early data request message including a non-access stratum (NAS) message to the base station by using an uplink grant resource indicated by the RAR message (S402). The NAS message may include a data payload including a small amount of user data or signaling data.

The base station may receive the RRC early data request message from the terminal. The base station may extract the NAS message from the RRC early data request message. The base station may transmit an initial UE message including the extracted NAS message to an access and mobility management function (AMF) of a 5G core (S403). The AMF may receive the initial UE message including the NAS message from the base station.

The 5G core may process the NAS request and data of the terminal and may transmit a downlink NAS transport message to the base station (S404). The base station may receive the downlink NAS transport message from the 5G core. The 5G core may transmit a connection establishment indication message indicating whether EDT is sufficiently completed or whether an additional connection is required to the base station (S405). The base station may receive the connection establishment indication message from the 5G core. The base station may transmit an RRC early data complete message to the terminal (S406). The terminal may receive the RRC early data complete message from the base station. The base station may trigger an RRC release after being synchronized with the 5G core, and may proceed with a release procedure (S407).

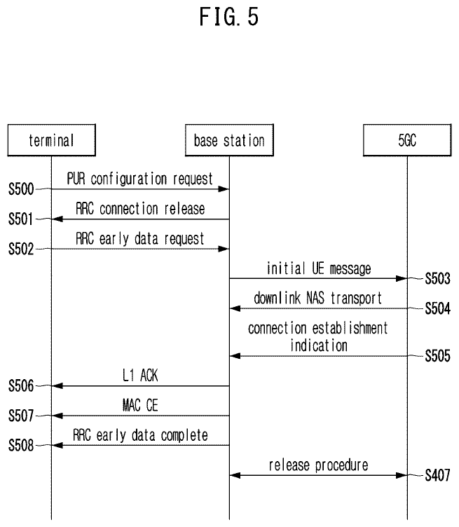

FIG. 5 is a sequence chart illustrating exemplary embodiments of a transmission method based on a preconfigured uplink resource.

Referring to FIG. 5, a terminal may request a PUR configuration from a base station (S500). The base station may receive the PUR configuration request from the terminal. The base station may transmit, to the terminal, an RRC release message including PUR configuration information including configuration parameters for PUR transmission (S501). The terminal may receive the RRC release message including the PUR configuration information including the configuration parameters for PUR transmission from the base station.

The terminal may transmit an RRC early data request message including a NAS message to the base station by using an uplink grant resource of PUR (S502). The NAS message may include a data payload including a small amount of user data or signaling data. The base station may receive the RRC early data request message from the terminal. The base station may extract the NAS message from the RRC early data request message. The base station may transmit an initial UE message including the extracted NAS message to an AMF of a 5G core (S503). The AMF may receive the initial UE message including the NAS message from the base station.

The 5G core may process the NAS request and data of the terminal and may transmit a downlink NAS transport message to the base station (S504). The base station may receive the downlink NAS transport message from the 5G core. The 5G core may transmit a connection establishment indication message indicating whether EDT is sufficiently completed or whether an additional connection is required to the base station (S505). The base station may receive the connection establishment indication message from the 5G core. The base station may transmit a layer 1 acknowledgement (L1 ACK), which starts after a certain time offset from a time when the uplink signal is transmitted, to the terminal (S506).

The terminal may receive the L1 ACK from the base station. The terminal may stop transmission of the uplink signal based on reception of the L1 ACK before a number of transmissions of the uplink signal reaches a repetition number. The base station may transmit a MAC CE including updated PUR configuration parameters for updating previous PUR configuration parameters to the terminal (S507). The terminal may receive the MAC CE including the updated PUR configuration parameters for updating the previous PUR configuration parameters from the base station and may update the PUR configuration parameters according to the received MAC CE.

The base station may transmit an RRC early data complete message to the terminal (S508). The terminal may receive the RRC early data complete message from the base station. The base station may trigger an RRC release after being synchronized with the 5G core and may proceed with a release procedure (S509).

In EDT and PUR schemes, a large number of terminals may simultaneously access in the IoT NTN network environment, and collision issues may occur and resource management complexity may increase due to constraints such as a long RTT. A random access procedure may have a high collision rate and may waste resources in the Msg1 and RA transmission process. In particular, to address specific requirements of the NTN environment (e.g. satellite-based long RTT and simultaneous access of a large number of terminals), the communication system may require a scheme for applying an improved CB-Msg3 transmission scheme and a DSA mechanism while maintaining compatibility with 3GPP NR and IoT standards.

The CB-Msg3 transmission scheme may be a transmission scheme for optimizing small data transmission in IoT and NTN environments. It may operate as a contention-based mechanism that allows terminals in an idle mode to transmit data using the same resource. The CB-Msg3 transmission scheme may reduce collision probability in an initial stage of message transmission and may increase data transmission efficiency. The CB-Msg3 transmission scheme may have the following characteristics.
Msg3 may be a message that enables a terminal to rapidly transmit data to a network without contention resolution through exchange of Msg1 (e.g. a random access channel (RACH) preamble) and Msg3 (RAR) in a random access procedure, and may include an RRC message and a data payload.
The CB-Msg3 transmission scheme may allow multiple terminals to transmit Msg3 by using the same resource. Therefore, unlike the PUR scheme, a collision possibility may exist in the CB-Msg3 transmission scheme.

The network may confirm whether a collision of Msg3 has occurred and, to resolve the collision, may transmit a message 4 (Msg4) (e.g. response message) to the terminal from which Msg3 has been successfully received.

The network may apply a contention resolution window configuration scheme for resolving a CB-Msg3 collision. The network may resolve the collision through Msg4 after Msg3 transmission. To this end, the network may apply the contention resolution scheme of the random access process to CB-Msg3. The network may include a UE contention resolution identity in Msg4 in the CB-Msg3 transmission scheme. Accordingly, the terminal may receive Msg4 including the UE contention resolution identity and may terminate early. The CB-Msg3 transmission scheme may adopt a scheme of transmitting the UE contention resolution identity and an RRC message together. Alternatively, the CB-Msg3 transmission scheme may adopt a scheme of transmitting the UE contention resolution identity and an RRC message separately.

The network may apply an operation optimization scheme after contention resolution. The present disclosure may more clearly define a state transition of the terminal after Msg4 reception. Msg4 may include a cell radio network temporary identifier (C-RNTI). In such a case, the terminal may monitor additional RRC messages. On the other hand, Msg4 may not include a C-RNTI. In such a case, the terminal may be configured to terminate the RRC procedure.

The network may apply a backoff scheme and an alternative access method when CB-Msg3 transmission fails. When CB-Msg3 transmission fails, immediately switching to a four-step RACH procedure may be inefficient. Therefore, after the CB-Msg3 failure, the terminal may perform retransmission after waiting for a backoff time configured by the base station. When CB-Msg3 transmission fails multiple times, the terminal may increase a coverage enhancement (CE) level and may perform retransmission, and the terminal may perform a stepwise fallback mechanism to eventually switch to a RACH-based access.

The network may apply a replica selection window optimization scheme for DSA. In a replica transmission scheme (e.g. DSA), the terminal may apply a sliding replica selection window and may start replica transmission based on the first transmission occasion. Through this, replica transmission may be performed efficiently.

The network may apply an RNTI calculation scheme for Msg4 based on DSA. The network may configure whether to calculate an RNTI for Msg4 per replica or whether to use a common RNTI. The network may configure the terminal to calculate an RNTI separately according to a transmission occasion of each replica.

The network may apply a contention resolution window optimization scheme based on DSA. The network may configure an appropriate contention resolution window to allow the terminal to correctly monitor Msg4. The network may support the terminal to receive Msg4 by configuring a separate contention resolution window for each replica transmitted by the terminal.

The network may apply a scheme of configuring one CB MsgB window for one DSA window. In this regard, the network may configure a CB MsgB window to efficiently process CB MsgA transmitted by multiple terminals in a DSA window. The terminal may wait for a certain time after transmitting CB MsgA. The terminal may require appropriate response timing configuration considering a round trip delay between the terminal and the base station. Through such configuration, the terminal may reduce unnecessary waiting time and may improve overall system performance.

The network may apply a monitoring start scheme that exempts narrowband physical downlink control channel (NPDCCH) monitoring for a certain time after transmitting the last narrowband physical uplink shared channel (NPUSCH) in the DSA window. In this regard, when the terminal monitors a downlink message immediately after completing an uplink transmission, power consumption may increase. The terminal may require a certain guard time when switching from uplink to downlink. An RTT in the NTN environment may be longer than an RTT in a terrestrial network (TN) environment. Therefore, the network may require a more flexible NPDCCH monitoring method compared to frequency division duplex (FDD).

The network may apply a scheme that restricts the terminal to perform only one CB-EDT procedure at the same time. When the terminal performs multiple CB-EDT procedures simultaneously, a collision possibility may increase, and a probability of unnecessary retransmissions may increase. When the terminal performs two CB-EDT procedures simultaneously, duplicate messages may be transmitted, and a processing load of the base station may increase. Therefore, the terminal may be restricted to perform one CB-EDT procedure to maintain consistency of network operations and to prevent confusion.

The network may apply a scheme of specifying a subcarrier start/end or a number of subcarriers in a CB-EDT configuration. The network may configure a subcarrier range to be used for each CE level at the terminal. The terminal may select an appropriate channel. When a subcarrier allocation scheme is unclear, interference among terminals may occur. Therefore, a clear subcarrier range configuration may be required.

The network may apply a scheme of including a modulation and coding scheme (MCS) index determining a modulation and a transport block size (TBS) in the CB-EDT configuration. In the NTN environment, a modulation scheme and a TBS may differ depending on a CE level. The network may specify an MCS index clearly to improve data processing efficiency and prevent confusion.

The network may apply a scheme of configuring transmission occasions for CB-MsgA for each CE level in the CB-EDT configuration. NTN terminals may operate in different coverage environments. The NTN terminals may have different transmission occasions depending on CE levels. The network may clearly provide transmission occasions per CE level to the terminal. The network may support the terminal to transmit CB-MsgA at an optimal timing.

The network may apply a scheme of configuring a repetition number for CB-MsgA per CE level. The NTN terminals may operate in a high-loss environment. Therefore, the NTN terminals may require multiple repeated transmissions. The network may configure an appropriate repetition number per CE level at the terminal and may secure optimal transmission and reception performance.

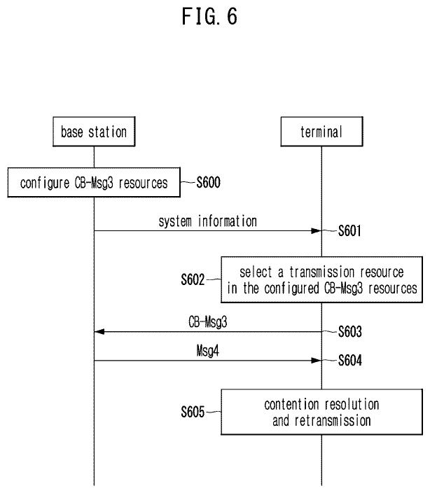

FIG. 6 is a sequence chart illustrating exemplary embodiments of a method for improving uplink capacity in a non-terrestrial network.

Referring to FIG. 6, a method for improving uplink capacity in an NTN (e.g. a signaling procedure for CB-Msg3 transmission) may be initiated by an RRC sublayer. Before a CB-Msg3 procedure is initiated, an NB-IoT terminal, a bandwidth reduced (BL) terminal, or a terminal having enhanced coverage in an NTN may have the following information available with respect to a serving cell.
A set of available PUSCH resources for CB-Msg3 transmission for each CE level supported in the serving cell
PUSCH resource selection criteria based on RSRP measurements per CE level supported in the serving cell

In the method for improving uplink capacity, the base station may configure resource groups for CB-Msg3 transmission. The resource group for CB-Msg3 transmission may be referred to as CB-Msg3 resources (S600). The base station may apply a resource pool configuration scheme based on CE levels to optimize resource configuration for CB-Msg3 transmission. Specifically, the base station may configure a separate resource pool per CE level in the NTN environment. In other words, the base station may configure a separate resource group per CE level in the NTN environment. By doing so, the base station may allow the terminal to select an appropriate resource from a resource group corresponding to a CE level. Enhanced machine-type communication (eMTC) may be designed to support up to 4 CE levels. NB-IoT may be designed to support up to 3 CE levels. This scheme may enable optimal resource selection based on a CE level and may increase a transmission success probability by minimizing resource collisions among terminals.

The base station may apply a scheme of optimizing a repetition number per CE level. The base station may configure a different PUSCH repetition number per CE level and may increase a repetition number at a CE level with low signal strength. The terminal may select an appropriate repetition number based on threshold(s) configured by the network. Accordingly, the network may guarantee stable transmission in an environment with severe signal attenuation and may reduce unnecessary repeated transmissions to save network resources.

The network may apply a scheme of configuring an MCS per CE level. The network may automatically adjust an appropriate MCS value depending on a CE level and may optimize transmission efficiency. Specifically, the network may apply a higher MCS as a CE level is lower (i.e. as the coverage is narrower). The network may apply a lower MCS as a CE level is higher (i.e. as the coverage is wider). Through this, the network may apply an optimal modulation scheme corresponding to each CE level, may improve transmission efficiency, and may enable flexible data processing based on signal quality in the NTN environment.

The network may apply a scheme of switching CE levels based on a reference signal received power (RSRP) threshold. When an RSRP value measured from a signal received from a current base station exceeds a predefined threshold, the terminal may maintain the CE level. When the RSRP value is below the threshold, the terminal may switch to a higher CE level. Through this, the terminal may increase accuracy of CE level selection, may maximize transmission performance, may prevent unnecessary CE level changes, and may improve network stability.

The network may apply a scheme of allocating subcarriers based on a CE level in the NTN environment. The network may configure start and end points of available subcarriers per CE level. Accordingly, the network may cause the terminal to select an appropriate channel. The network may allocate a different number of subcarriers per CE level considering characteristics of the NTN. By doing so, interference among terminals may be minimized, and signal quality may be improved.

The network may apply a scheme of introducing a resource pool per CE level to manage CB-Msg3 EDT PUSCH resources. In CB-Msg3 EDT, PUSCH resources may be configured as a pool shared among multiple terminals. The network may allocate PUSCH resources per CE level. The terminal may select and use resources suitable for the corresponding CE level.

The terminal may select PUSCH resources from a resource pool per CE level and may perform replica transmissions. When the terminal selects a specific CE level, the network may configure the terminal to select PUSCH resources from a resource pool corresponding to the CE level. Through this, the network may efficiently manage uplink resources corresponding to the CE level of the terminal. The network may configure a repetition number per CE level. The network may associate a repetition number per CE level with a resource pool per CE level. The network may clearly configure a repetition number per CE level to support repeated transmission in CB-Msg3 EDT. The network may cause the terminal to transmit in a consistent manner by configuring the repetition number per CE level.

The network may configure system information to provide CB-Msg3 PUSCH resources per cell. The terminal may select resources based on RSRP threshold(s) and a CE level. The terminal may replicate Msg3 multiple times using DSA within a defined time window and may transmit the replicated Msg3s to the base station. Each replica may be managed through a HARQ process that is treated as an independent transmission. Transmission collisions may be mitigated through a backoff mechanism.

The network may predefine key elements that need to be essentially included in a CB-Msg3 shared resource configuration. These key elements may be for guaranteeing efficient data transmission in the NTN environment. For example, the CB-Msg3 shared resource configuration may include time-domain resources for (N) PUSCH transmission occasions. The time-domain resources for (N) PUSCH transmission occasions may include a periodicity and a start time (e.g. a start subframe, a start system frame number (SFN), and the like). The CB-Msg3 shared resource configuration may include frequency-domain resources for (N) PUSCH transmission occasions. The CB-Msg3 shared resource configuration may include a repetition number, (N) PDCCH resources, and MCS information. These elements may be for guaranteeing efficiency and reliability of CB-Msg3 transmission in the NTN network environment.

Specifically, information on resource groups (i.e. resource group information) may include at least one of a resource group per CE level, a repetition number, a period, or a backoff timer value. Here, a “resource group per CE level” may mean a resource group classified according to a signal strength at the terminal. Specifically, the resource group per CE level may include, for each CE level, at least one of resources, a maximum TBS, or a repetition number. A number of CE levels for CB-Msg3 EDT resources may be the same as a number of CE levels for PRACH resources. However, CE level thresholds for CB-Msg3 EDT resources may be configured separately from CE level thresholds for PRACH resources. A maximum TBS of CB-Msg3 EDT may be configured differently per CE level.

The network may apply a scheme of differentially configuring a TBS per CE level. In the NTN environment, signal attenuation and transmission success rate may differ per CE level. The network may configure an optimal TBS suitable for each CE level. The network may allocate a larger TBS as a CE level is lower (i.e. as signal strength is stronger) and may allocate a smaller TBS as a CE level is higher (i.e. as signal attenuation is greater), thereby optimizing signal transmission. The network may maintain a constant TBS increase rate at CE levels 0 to 2. The network may limit a TBS size at CE level 3. By doing so, the network may prevent waste of network resources. Through this, the network may support data transmission optimized per CE level at the terminal and may maximize transmission and reception performance.

The network may apply a scheme of configuring a TBS independently of PRACH CE levels. The network may configure the terminal to enable selection on whether to configure a CB-Msg3 TBS in the same manner as existing PRACH CE levels. The network may apply an individual configuration scheme suitable for the NTN environment by separating a PRACH CE level and a TBS threshold of CB-Msg3. The network may secure reliability by decreasing a TBS size while increasing a repetition transmission number as a CE level increases. Through this, the network may flexibly adjust a CB-Msg3 TBS while maintaining consistency with an existing PRACH CE level configuration.

The network may apply a scheme of adaptively adjusting a TBS per CE level. The network may apply a scheme of automatically adjusting an appropriate TBS suitable for each CE level by analyzing a transmission environment at the terminal in real time. The network may evaluate a signal state of the terminal based on an RSRP value and may dynamically adjust the TBS. The network may configure the TBS to vary to an optimal value in real time in consideration of a data transmission and reception success rate, instead of keeping the TBS constant. Through this, the network may enable dynamic adaptation at the terminal according to a change of signal state and may provide optimal data processing per CE level.

The network may apply a scheme of optimizing linkage between a TBS and an MCS based on CE levels. In the NTN environment, the network may apply a scheme of operating harmoniously a TBS by configuring an MCS differently per CE level. The network may increase transmission reliability by applying a low MCS at CE levels 0 to 3. The network may configure the TBS and the MCS value to compensate for data loss due to signal attenuation. Through this, the network may optimize a combination of the TBS and the MCS and may maximize data transmission performance in the NTN environment.

The network may apply a scheme of optimizing a TBS in conjunction with hybrid automatic repeat request (HARQ) in the NTN. In the NTN environment, HARQ retransmission may occur with high probability. The network may optimize a TBS per CE level in consideration of HARQ. The network may adjust an initial TBS based on HARQ feedback. The network may apply a scheme of gradually decreasing the TBS when retransmission occurs more than a certain number of times. Through this, the network may reduce network load by minimizing HARQ-based data retransmission in the NTN environment, may reduce retransmission burden through TBS adjustment per CE level, and may improve a data transmission success rate.

A scheme of configuring a number of CE levels for CB-Msg3 EDT resources to be the same as a number of PRACH CE levels may be applied. Currently, CE levels of PRACH provide wide coverage across the network. When the same number of CE levels is maintained in CB-Msg3 EDT, network operation may be simplified, and network configuration may be possible based on the PRACH CE levels.

The network may configure CE level thresholds of CB-Msg3 EDT to be set independently of PRACH CE level thresholds. When the network independently configures the PRACH CE level thresholds and the CE level thresholds of CB-Msg3 EDT, a more flexible policy may be established. In addition, the network may configure a maximum TBS of CB-Msg3 EDT differently per CE level. A transmittable data size may differ depending on a CE level. When the base station applies such a scheme, a change of link state in the NTN environment may be effectively addressed.

The network may configure a maximum TBS threshold of CB-Msg3 EDT per CE level. The network may determine whether to use the same value for the maximum TBS threshold of CB-Msg3 EDT across CE levels. A maximum TBS of CB-Msg3 EDT may have a direct relationship with coverage conditions of the terminal. The network may enable flexible operation by configuring a maximum TBS threshold per CE level in the same manner as in EDT.

The network may support configuration of CB-Msg3 EDT resources on anchor and non-anchor carriers in NB-IoT. In an existing EDT, PRACH resources may be configured on anchor and non-anchor carriers per CE level. CB-Msg3 EDT may be configured in the same manner, thereby supporting load distribution of the network and efficient resource use. In addition, CB-Msg3 EDT resources may be supported to be configurable with various numerologies (e.g. 3.75 kHz subcarrier spacing (SCS), 15 kHz SCS, and the like). An uplink grant of NB-IoT may be configured with 3.75 kHz and 15 kHz SCS, and the network may select an appropriate numerology according to radio link quality. CB-Msg3 EDT may also require support of various SCS configurations to operate in various environments.

The network may apply a scheme of configuring a maximum TBS of CB-Msg3 differently per CE level. An existing EDT may define a TBS per CE level and may optimize a transmission repetition number and resource consumption. CB-Msg3 EDT may apply the same principle, may configure a maximum TBS per CE level, and may enable more flexible configuration of uplink transmission.

The network may introduce a flexible TBS selection function based on a pending data size of the terminal. An existing EDT may reduce transmission of unnecessary padding bits by configuring the terminal to select a TBS. CB-Msg3 may introduce a similar function and may enable optimization of network resource use. The network may introduce separate RSRP thresholds for CE level selection of CB-Msg3. Unlike an existing RACH CE level selection scheme, CB-Msg3 may be transmitted directly through a PUSCH. The network may configure consideration of an uplink MCS and a resource configuration in CE level selection at the terminal. Therefore, the network may introduce separate RSRP thresholds and may allow more accurate determination of a CE level of CB-Msg3.

The network may provide a maximum TBS per CE level. The network may determine whether to use the same value across CE levels. An existing EDT may configure a maximum TBS per CE level. CB-Msg3 EDT may reuse this scheme. The network may flexibly determine whether to maintain the same TBS value at a specific CE level.

The network may consider various options for a DSA CB-Msg3 transmission occasion selection window. When the terminal transmits multiple replicas, an optimal window configuration to minimize replica collisions may be required. In one option, the network may configure one large time window. The terminal may randomly select a time slot and may transmit a replica. In another option, the network may configure multiple individual windows according to a number of replicas. The terminal may transmit each replica in a separate window. In yet another option, the network may configure multiple windows. The terminal may select a random time slot in each window and may transmit a replica. In this case, a number of replicas and a number of windows may not match. Through these various options, the network may select an optimal transmission scheme in the NTN environment.

The “repetition number” may mean a number of times that the terminal may repeatedly transmit the same CB-Msg3. The repetition number may be applied to reduce a collision probability among terminals due to use of common resources. The “period” may mean a time interval of transmission occasions within a resource group. Specifically, the network may configure the periodicity with a start time (i.e. definition of the first transmission occasion of the resource group) and a periodicity (i.e. a time interval between transmission occasions within the resource group). The “backoff timer value” may mean a time that needs to elapse at the terminal before attempting retransmission when CB-Msg3 transmission fails. The backoff timer value may be dynamically configured by the network according to implementations of the present disclosure.

The network may broadcast information on configured resource groups (i.e. CB-Msg3 resource configuration) (S601). For example, the network may broadcast information on the resource groups (i.e. resource group information) by using a system information block (SIB). For example, the SIB used to broadcast information on the resource groups may be an existing SIB1. The SIB used to broadcast information on the resource groups may be selected as a SIB including NTN-related information. The SIB used to broadcast information on the resource groups may not be limited thereto.

According to implementations of the present disclosure, a new SIB may be defined to broadcast information on the resource groups, in consideration of an overhead or influence on legacy terminals. CB-Msg3-related specific configurations may be included in one field included in SIB2(−NB). Presence or absence of the CB-Msg3-specific field may indicate whether the terminal is able to start CB-Msg3 EDT in the cell.

The SIB may include one CB-Msg3 resource configuration. The resource configuration may be at least one of single ALOHA (SA), DSA, OCC2, or a combination of DSA and OCC2.

The terminal may use such a resource configuration and may avoid complexity of determining a priority among different resource configurations.

The network may apply a scheme of configuring at most one CB-Msg3 resource configuration in the SIB. By doing so, the network may prevent confusion when the terminal selects CB-Msg3 resources and may enable simple resource selection. The network may include at least one of SA, DSA, OCC2, or DSA and OCC2 as a resource configuration in the SIB. The base station may configure multiple resources. In such a case, the terminal may require a complicated procedure to determine a priority. The network may configure the SIB to support a combination of DSA and OCC2. DSA may be a scheme of increasing uplink capacity by transmitting multiple Msg3 replicas to reduce a collision probability. OCC2 may be a technique for improving uplink spectrum efficiency. By combining the two techniques, the network may secure further improved uplink processing capacity.

For example, the network may configure a CE level of CB-Msg3 as 0, 1, or 2 and may not support CE level 3. CB-Msg3 may be intended for small data transmission. It may be difficult to utilize CB-Msg3 under extreme coverage conditions (e.g. CE level 3).

The terminal may receive the system information including information on the resource groups (i.e. CB-Msg3 resource configuration) from the base station. The terminal may select a CE level based on the received information on the resource groups and a signal strength at the terminal. In this regard, according to an exemplary embodiment of the present disclosure, the CB-Msg3 configuration may follow the following RSRP measurement-based rules:
An RSRP measurement value may be less than RSRP threshold 3. In such a case, the network may apply a RACH procedure.
An RSRP measurement value may be equal to or greater than RSRP threshold 3 and may be less than RSRP threshold 2. The network may apply CB-Msg3 CE level 2.
An RSRP measurement value may be equal to or greater than RSRP threshold 2 and may be less than RSRP threshold 1. The network may apply CB-Msg3 CE level 1.
An RSRP measurement value may be equal to or greater than RSRP threshold 1. The network may apply CB-Msg3 CE level 0.

The network may configure different CE level thresholds for eMTC NTN and NB-IoT NTN. In the case of eMTC NTN, the network may support up to three separate RSRP thresholds in addition to a minimum RSRP threshold and may achieve up to four CE levels. These thresholds may differ from thresholds for PRACH. In the case of NB-IoT NTN, the network may support up to two separate RSRP thresholds in addition to a minimum RSRP threshold and may achieve up to three CE levels. These thresholds may differ from thresholds for PRACH. Through such differentiated threshold configurations, the network may provide optimal coverage enhancement suitable for a network environment.

The CB-EDT configuration may include a minimum RSRP threshold for using CB-EDT. The CB-EDT configuration may include two RSRP thresholds for three CE levels for NB-IoT and three RSRP thresholds for four CE levels for eMTC. Through such threshold configurations, the terminal may select an appropriate CE level suitable for a current signal state, may increase a transmission success rate, and may optimize use of network resources.

The network may reuse RSRP thresholds of an existing EDT at CE level selection and may apply a scheme of configuring additional RSRP thresholds for determining whether to use CB-Msg3 EDT for each CE level. The existing EDT and CB-Msg3 EDT may have different purposes. The existing EDT and CB-Msg3 EDT may determine CE levels based on RSRP. Reusing RSRP thresholds used in the EDT as they are and additionally configuring RSRP thresholds for determining whether to use CB-Msg3 EDT per CE level may be simpler and may maintain consistency with existing standards.

The network may determine an RSRP threshold for determining whether to apply OCC in CB-Msg3 EDT. One of conditions for applying OCC may be that “a power imbalance among terminals is small”. When the network configures the RSRP threshold in such a manner, a power imbalance among terminals may be minimized and application of OCC may be facilitated.

The terminal may select a target resource for CB-Msg3 transmission within a resource group corresponding to a selected CE level. In other words, the terminal may select a transmission resource from configured CB-Msg3 resources corresponding to the selected CE level (S602). For example, the terminal may select a target resource by sequentially using the resource group information of system information and a signal strength (e.g. RSRP, received signal strength indicator (RSSI), and the like).

For example, the terminal may first select an appropriate CE level based on a signal strength on the basis of the resource group information provided through the SIB. The terminal may randomly select a resource within a resource group corresponding to the selected CE level. The terminal may maximize resource efficiency by utilizing existing TBS and CE level configurations. For example, the terminal may assign a priority according to the signal strength based on an RSRP threshold and, by selecting frequency and time resources corresponding to each priority, may select resources of the appropriate CE level for the signal strength.

The terminal may exemplarily perform selection of the CE level in the following order.

When an RSRP threshold of CE level 3 is configured by a higher layer and a measured RSRP may be less than the threshold, the terminal may support CE level 3. In such a case, a MAC entity of the terminal may regard the terminal as belonging to CE level 3.

Alternatively, an RSRP threshold of CE level 2 may be configured. When the measured RSRP may be less than the threshold, the terminal may support CE level 2. The MAC entity of the terminal may regard the terminal as belonging to CE level 2. In another example, when the measured RSRP may be less than an RSRP threshold of CE level 1, the MAC entity of the terminal may regard the terminal as belonging to CE level 1. Otherwise, the MAC entity of the terminal may regard the terminal as belonging to CE level 0.

The terminal may transmit a CB-Msg3 to the base station by using the selected target resource (S603). The CB-Msg3 may include an RRC early data request message and a data payload. In this regard, the CB-Msg3 transmission procedure may be the same as an existing uplink transmission scheme (i.e. grant-based transmission scheme). The CB-Msg3 EDT may be the same as an existing uplink transmission process. The terminal may start an individual CB-Msg3 monitoring window after transmitting each replica. The network may configure an individual monitoring window for each replica. Accordingly, the terminal may reduce unnecessary PDCCH monitoring.

The terminal may monitor a PDCCH-RNTI for each replica and may receive the message. The terminal may regard CB-Msg3 transmission as a failure when a CB-Msg3 monitoring window of the last replica ends. The terminal may not receive a response after transmitting all replicas. In that case, the terminal may regard CB-Msg3 EDT as a failure and may perform a retry or another procedure. The terminal may start an individual response reception window after transmitting each replica by using the DSA scheme. Since the terminal transmits multiple replicas by using the DSA scheme, the terminal may start an individual response reception window for each replica and may optimize signal processing.

The terminal may transmit a replica message identical to CB-Msg3 within a predetermined time window by using the DSA scheme. In other words, the terminal may select either replica transmission or single transmission when transmitting CB-Msg3. Here, the single transmission may mean transmitting CB-Msg3 once by using a target resource selected at the terminal. In contrast, the replica transmission may mean transmitting the same CB-Msg3 by using multiple target resources by using the DSA scheme at the terminal. Each replica message may be processed independently, and a transmission success probability may be increased thereby.

In this regard, the network may apply a scheme of not using DSA CB-Msg3 resources configured with K=1 (i.e. K refers to a number of replicas or a number of repetitions) for a terminal that does not support the DSA function. A new terminal may use a mixture of the DSA transmission scheme and the single attempt (SA) transmission scheme per CE level. For example, the new terminal may use K=1 at CE level 0 and may use K=2 at CE level 1.

However, the network may simplify the procedure by disabling use of K=1 resource at the terminal that does not support the DSA function. Through DSA resource configuration, the terminal may recognize whether the network supports DSA. Through DSA resource configuration, the network may recognize whether the terminal supports DSA. By configuring DSA resources, the network may verify whether the terminal supports DSA. When the terminal uses DSA resources, the network may recognize that the terminal supports the DSA function. When the network and the terminal recognize DSA support through DSA resource configuration, efficient resource management in the NTN environment may be facilitated.

When the DSA scheme is applied, the terminal may randomly select PUSCH resources up to a maximum repetition number within a configured time window. In this case, each replica transmission may be treated as a new transmission. The MAC entity of the terminal may generate a MAC PDU for each replica transmission. From the second replica transmission, the terminal may obtain a MAC PDU from a HARQ buffer. The physical layer of the terminal may process each replica transmission as an independent new transmission in the same manner as an existing scheme. Each replica transmission may use HARQ process ID 0 and redundancy version (RV) 0, similarly to Msg3 transmission.

The network may apply a scheme of regarding each CB-Msg3 replica transmission as a new transmission at the MAC layer. Due to characteristics of DSA, the network may not know a transmission position of each replica in advance. Accordingly, soft combining at the network may be difficult. When each replica is regarded as an independent transmission, HARQ processing and power control may be simplified. A HARQ entity of the terminal may obtain a MAC PDU from a HARQ buffer and may perform replica transmission.

All replicas may have identical content. Accordingly, reusing an identical PDU from the HARQ buffer at the terminal may be efficient. In addition, the terminal may use HARQ process ID 0 and RV 0 for CB-Msg3 transmission. Consistency with existing Msg3 transmission may be maintained, and the HARQ process may be simplified.

The network may apply a scheme of maintaining a basic procedure utilizing a PUSCH resource per cell for CB-Msg3 EDT transmission. The network may configure the PUSCH resource through system information. The terminal may transmit a message by utilizing the PUSCH resource. This transmission scheme may be consistent with the existing EDT transmission scheme. Through this, implementation complexity may be reduced, and interoperability may be guaranteed. The network may increase uplink capacity by efficiently utilizing PUSCH resources. This scheme may enable efficient data transmission between the terminal and the network in the NTN environment.

In the DSA scheme, the terminal may start a separate PDCCH monitoring window for each replica transmission. The terminal may perform monitoring by using an RNTI associated with the replica transmission in each window. Multiple windows may overlap. In such a case, the terminal may determine which PDCCH scrambled with which RNTI to monitor according to a PDCCH reception capability of the terminal. All response windows may expire. The terminal may not receive a response matching the replica transmission. In such a case, the terminal may attempt a next CB-Msg3 transmission.

In this regard, the network may apply a scheme of maintaining an individual PDCCH monitoring window for each Msg3 replica in the DSA scheme. When one monitoring window is used, the terminal may need to monitor the monitoring window by using multiple RNTIs simultaneously, thereby increasing power consumption. Therefore, the network may configure the terminal to maintain an independent PDCCH monitoring window for each replica.

Upon completion of contention resolution, the terminal may stop all PDCCH monitoring windows. Unnecessary PDCCH monitoring may be reduced, power consumption may be minimized, and network resources may be utilized efficiently at the terminal. This scheme may contribute to extending the terminal's battery operating time in the NTN environment.

The network may configure the terminal to transmit one or more CB-Msg3 replicas by using the DSA scheme. A number of replicas may be specified per CE level among 1 (SA), 2, 3, or 4. According to an exemplary embodiment of the present disclosure, the network may apply a scheme of dynamically starting a transmission window using the DSA scheme according to a transmission time of the first replica. In a fixed transmission window scheme, the terminal may start DSA in a latter part of the transmission window. In such a case, sufficient transmission occasions may not be secured at the terminal. In contrast, in a dynamic transmission window scheme, the terminal may start a window based on the transmission time of the first replica.

Sufficient transmission occasions may always be secured at the terminal. Through this, unnecessary delay may be prevented at the network, and a network collision probability may be reduced. According to an exemplary embodiment of the present disclosure, the terminal may receive CB-Msg4 including a matching UE contention resolution identity before transmitting all replicas. In such a case, the terminal may stop transmission of remaining replicas. According to an exemplary embodiment of the present disclosure, within a configured time window, the terminal may randomly select different time-domain transmission occasions for different replica transmissions. The terminal may randomly select frequency-domain resources for each time-domain transmission occasion.

The network may apply a scheme of configuring a DSA-based replica selection window. The terminal may be configured not to arrange replicas randomly when transmitting CB-Msg3 but to transmit within the predefined replica selection window. The network may configure the terminal to transmit multiple replicas by applying the DSA scheme and to arrange the replicas uniformly within the specific window. By configuring in this manner, the network may reduce a message collision probability among terminals, may maximize utilization of network resources, and may increase transmission efficiency.

The network may configure the terminal to implement a sliding replica selection window. Specifically, when transmitting CB-Msg3, the terminal may apply a sliding window scheme of adjusting subsequent replica transmissions based on the first transmission occasion. After selecting a next transmission window, the terminal may randomly transmit K replicas. In this manner, the network may distribute transmission timing of replicas to prevent collisions and may optimize replica transmission in consideration of RTT delay in the NTN environment.

The network may apply a scheme of adjusting a transmission timing per replica. The network may distribute timings of the respective replicas transmitted by the terminal. Accordingly, collisions of replicas transmitted in the same subframe at the terminal may be prevented. The network may be designed so that the replicas are transmitted at a constant interval, and this may increase resource utilization. A collision probability for transmissions by multiple terminals may be reduced at the network, and a transmission success rate may be increased.

The network may apply a scheme of optimizing an RNTI configuration scheme at individual replica transmission. The network may determine whether to allocate an RNTI individually for each replica transmitted by the terminal. The network may determine whether to use a common RNTI for replicas transmitted by the terminal. A specific terminal may transmit multiple replicas. In such a case, when the network allocates an individual RNTI per replica, identification in a collision may be facilitated. Through this, the network may individually identify replicas and may increase a collision resolution speed. A probability of effectively receiving multiple replicas at the network in the NTN environment may be increased.

The network may apply a PDCCH monitoring optimization scheme for replica monitoring. The network may cause the terminal to configure an individual PDCCH monitoring window after transmission of each replica so that the terminal is able to receive Msg4. In the NTN environment, the terminal may have difficulty in quickly confirming whether a replica is received due to an RTT longer than that of the TN environment. The network may apply an optimization scheme for a monitoring window to compensate for this. Through this, the terminal may monitor a prompt response after replica transmission and may reduce PDCCH monitoring burden to extend the terminal's battery operating time.

The network may configure a transmission window of CB-Msg3 for the terminal. The network may configure the transmission window of CB-Msg3 for the terminal by using at least one of a starting time (e.g. hyper system frame number (H-SFN) offset), a window length, or a window periodicity. The window length and the periodicity may be identical. When k=1, the window length may be equal to 1, and this may be identical to a current operation scheme. The terminal may first select a next DSA transmission window, and then may randomly select K replicas within the window. This scheme may minimize transmission collision and may enable efficient resource utilization.

The network may apply a scheme to define a configurable time window of DSA as N consecutive CB-Msg3 EDT resources. The terminal may transmit several Msg3 replicas by using the DSA scheme. A certain time window may be required for this. The network may allow the terminal to randomly select replicas by using N consecutive PUSCH resources. Through this, the network may optimize resource usage.

The network may configure a configurable time window of DSA to start from a next available CB-Msg3 EDT PUSCH resource. The DSA scheme may not require a fixed detection window unlike a collision resolution diversity slotted ALOHA (CRDSA) scheme. Accordingly, the network may reasonably configure the configurable time window of DSA to start from a nearest available PUSCH resource. The network may not consider an additional delay processing time for starting a response reception window after completion of one CB-Msg3 PUSCH transmission. In the DSA scheme, one replica may not depend on other uplink transmissions. The network may not consider additional processing delay.

The network may configure the first transmission occasion (e.g. TO1) for a DSA replica group for the terminal. The network may apply a scheme to configure replica transmission occasions after the first transmission occasion on the basis of the first transmission occasion. In the DSA scheme, an interval between replica transmissions may be too large. In such a case, some terminals may receive Msg4 early at TO1. Accordingly, an effect of the DSA scheme may be limited.

Therefore, the network may appropriately adjust an interval between replica transmission occasions, may minimize an overall delay, and may maximize an effect of the DSA scheme. The network may support the terminal to configure a periodicity of DSA transmission occasion groups. The network may configure an interval between the transmission occasions groups so that performance of DSA may be optimized. Through this, efficient resource utilization may be possible in the NTN environment.

In the DSA scheme, when transmitting CB-Msg3, the terminal may apply a scheme to complete replica transmissions within a time window configured by the network. The terminal may complete replica transmissions within a time configured by the network. Then, response delay may be minimized. After Msg3 replica transmissions, the network may configure the terminal to start an individual Msg4 reception window for each replica.

A time synchronization issue between the network and the terminal may be minimized by performing individual PDCCH monitoring for each Msg3 replica. All Msg4 reception windows may be terminated. In such a case, the terminal may regard that contention resolution fails. The terminal may transmit multiple Msg3 replicas. The terminal may regard failure after all reception windows are terminated. This scheme may increase reliability of replica transmission in the NTN environment.

The network may receive at least one of CB-Msg3 and a replica message corresponding to CB-Msg3 from the terminal. The network may transmit Msg4 to the terminal in response to the received message (S604). The terminal may receive Msg4 from the base station. According to an exemplary embodiment of the present disclosure, in the DSA scheme, when the base station successfully decodes one among multiple replicas, the network may not wait for reception of remaining replicas and may transmit a response to the terminal for the received message. The terminal may determine whether CB-Msg3 transmission is successful based on a MAC CE included in received Msg4. When the terminal determines that transmission fails, the terminal may select a new target resource after a backoff period and may retransmit CB-Msg3 (S605).

In this regard, the network may apply a scheme to include a MAC CE based on a terminal ID in Msg4 for contention resolution of CB-Msg3 EDT. CB-Msg3 EDT may allow multiple terminals to share identical resources. Accordingly, a collision probability may be high in CB-Msg3 EDT. CB-Msg3 EDT may perform contention resolution by using a MAC CE including a terminal ID in Msg4, similarly to the contention resolution scheme used in the existing RACH procedure. The network may extract the terminal ID from Msg3 and may notify the terminal that wins contention resolution through Msg4.

The terminal may fail CB-Msg3 EDT transmission. In such a case, the terminal may apply the backoff timer configured in system information and may retry CB-Msg3 EDT transmission. In the existing RACH procedure, the terminal may randomly select a retry time by using a backoff indicator. Similarly, when CB-Msg3 EDT introduces a backoff mechanism, a collision probability may be reduced.

The network may include the backoff indicator in system information and may transmit it to the terminal. The terminal may receive the system information and may identify the backoff indicator from the received system information. The terminal may apply a random backoff before retransmission based on the backoff indicator.

The network may use a contention resolution timer as a PDCCH monitoring window and may apply a scheme to start the contention resolution timer by reflecting an RTT between the terminal and the base station after transmission of the first replica. Contention resolution may proceed in the same manner as the existing EDT procedure and may be performed in association with the PDCCH monitoring window. When the terminal starts the contention resolution timer after transmission of the first replica, a probability of rapid reception of Msg4 may increase.

Additionally, the network may apply a scheme to maintain the existing contention resolution procedure of EDT (e.g. a scheme of using a contention resolution timer and a MAC CE). In other words, the network may simplify a procedure by using the same mechanism as the existing Msg4 contention resolution scheme. This mechanism may enable efficient contention resolution in the NTN environment.

The network may apply a scheme to configure a new RSRP threshold in the terminal to determine a CE level when CB-Msg3 transmission fails in the terminal. A threshold used to determine a CE level of CB-Msg3 and a CE level threshold of an existing PRACH may differ. Accordingly, the network may configure the terminal with a new threshold for a CE level of CB-Msg3. The terminal may perform more accurate coverage determination.

The network may apply a scheme to set a number of CB-Msg3 CE levels identical to a number of PRACH CE levels. When the network sets the number of PRACH CE levels and the number of CB-Msg3 CE levels identical, standard consistency may be maintained. When the network sets the number of PRACH CE levels and the number of CB-Msg3 CE levels identical, the network may configure a maximum number of retransmissions through system information when CB-Msg3 transmission fails. Thereafter, when the network sets the number of PRACH CE levels and the number of CB-Msg3 CE levels identical, a fallback may be made to a four-step RACH procedure. CB-Msg3 transmission may fail more than a certain number of times. The terminal may transition to the existing four-step RACH procedure. The network may configure a maximum number of retransmissions through system information.

The network may apply a scheme to determine an RNTI based on the corresponding PUSCH resource when transmitting CB-Msg3 PUSCH. In the existing RACH procedure, the network may allocate a temporary cell-RNTI (TC-RNTI) to the terminal through RAR. The terminal may determine an RNTI based on a PUSCH resource in the CB-Msg3 transmission scheme. The terminal may reuse the existing contention resolution scheme of the four-step RACH (e.g. terminal identification in Msg4) in CB-Msg3 EDT.

Specifically, after transmitting Msg3, the terminal may achieve contention resolution through a MAC CE including a terminal ID in Msg4. After CB-Msg3 transmission, the terminal may start a response reception window by reflecting RTT between the terminal and the base station after the last PUSCH repetition is completed. This scheme may be an approach that considers only RTT for simplification unlike the existing PUR scheme.

The terminal may perform monitoring to receive a response from the network within a specific time window after transmission of CB-Msg3. Such a PDCCH monitoring window may be configured as a single window corresponding to both a single transmission case and a replica transmission case using the DSA scheme, but may not be limited thereto.

The network may apply a CE level-based PDCCH monitoring window optimization scheme. The network may configure a PDCCH monitoring window differently for each CE level to reduce power consumption of the terminal in the NTN environment. The network may shorten a monitoring periodicity when a CE level is low (i.e. when a signal is strong), and may lengthen a monitoring periodicity when a CE level is high (i.e. when a signal is weak). The terminal may minimize battery consumption by adjusting a monitoring periodicity and a repetition number for NPDCCH differently based on the CE level. Through this, the terminal may reduce an unnecessary monitoring burden and may minimize power consumption. The terminal may reduce a monitoring burden in the NTN environment and may extend battery operating time.

The network may apply a PDCCH monitoring duty cycle adjustment scheme. The network may adjust a monitoring duty cycle so that the terminal does not perform unnecessary PDCCH monitoring due to an RTT of the NTN environment longer than an RTT of the TN environment. The terminal may perform PDCCH monitoring at a certain interval after transmitting Msg3. When there is no response, the terminal may extend the period to reduce monitoring burden. The terminal may configure a shorter monitoring period when the CE level is low, and may configure a longer monitoring period when the CE level is high to optimize the configuration. Through this, the terminal may minimize power consumption and may maintain a reception rate of Msg4.

The network may apply a monitoring window optimization scheme considering an RTT of the NTN environment longer than that of the TN environment. Propagation delay may be large in the NTN environment. The terminal may configure a longer PDCCH monitoring window than that of the TN environment and may reliably receive Msg4. After transmitting Msg3, the terminal may adjust a starting time of a monitoring window by reflecting the RTT between the terminal and the base station. The terminal may consider characteristics of NTN, may adjust a starting time of a monitoring window, and may minimize a signal monitoring burden. Through this, the terminal may reduce a reception failure rate of Msg4 in the NTN environment and may secure reliability.

The network may implement a scheme of applying an independent PDCCH monitoring window after transmission of each replica for the terminal. After transmitting a replica of CB-Msg3, the terminal may configure an independent PDCCH monitoring window for each replica and may rapidly receive Msg4. Since an RTT in the NTN environment may be longer than that in the TN environment, the terminal may have difficulty in quickly confirming whether the replica is received. To compensate for this, the terminal may apply a monitoring window optimization scheme. Through this, the terminal may monitor a response rapidly after transmitting the replica. The terminal may reduce PDCCH monitoring burden and may extend battery operating time.

The terminal may apply a scheme to start a PDCCH monitoring window after transmission of each CB-Msg3 replica. The terminal may prevent unnecessary replica transmissions by receiving a response early after a replica transmission and may reduce network resource consumption. When the PDCCH monitoring window expires and a response is not received, the terminal may perform new transmission of CB-Msg3. When there is no response, a procedure that allows retransmission of the terminal may be required. Through this, the terminal may effectively maintain network connectivity.

The terminal may apply a scheme to configure a PDCCH monitoring window by considering a processing time of the base station. The terminal may reflect a processing delay of four subframes when starting a response window in the existing PUR scheme. CB-Msg3 EDT may be a scheme that includes contention. The processing time of the base station may increase. The terminal may determine an appropriate processing delay value in consideration of such a situation.

CB-Msg4 may not include an RRC message. In such a case, CB-Msg4 may include a C-RNTI so that the terminal may receive an RRC message later. In the existing EDT scheme, Msg4 may not include an RRC message. In such a case, the terminal may additionally monitor an RRC message. CB-Msg3 EDT may require the same scheme. The network may include a C-RNTI in Msg4 to support data reception of the terminal thereafter. The network may determine whether network-scheduled retransmission of CB-Msg3 EDT is supported. In the existing EDT, the network may schedule Msg3 retransmission based on a TC-RNTI.

The terminal may apply a scheme to use only one RNTI within one PDCCH monitoring window. When the terminal uses multiple PDCCH monitoring windows, the terminal may monitor multiple RNTIs simultaneously, which may increase complexity.

In contrast, the terminal may use one window and one RNTI. In such a case, the network may efficiently transmit Msg4 through a multicast scheme. The terminal may apply a scheme to use a single PDCCH monitoring window. When one window is used, the terminal may not need to monitor multiple Msg4. The terminal may prevent unnecessary resource waste. This may extend the battery operating time of the terminal in the NTN environment.

The terminal may apply the scheme to start or restart a PDCCH monitoring window after four subframes and the RTT between the terminal and the base station after completion of CB-Msg3 transmission in the SA scheme. Similarly to the existing PUR scheme, the terminal may consider processing delay when starting a PDCCH monitoring window. The terminal may support multiple PDCCH monitoring windows in DSA. When one long monitoring window is used, power consumption of the terminal may increase. Instead, when the terminal uses a separate monitoring window for each replica, the terminal may independently confirm a response for each replica. The terminal may receive Msg4 based on a different RNTI for each replica in the DSA scheme. The network may calculate an RNTI based on a replica transmission resource and may transmit Msg4 such that the terminal may process Msg4 of each replica individually.

In summary, according to an uplink capacity improvement technique for IoT NTN through contention-based early data transmission, after the network configures CB-Msg3 resources, the network may broadcast resources for CB-Msg3 transmission through an SIB. The resource configuration may include the following elements and may not exclude additional elements. In other words, the SIB may include parameters such as resource groups per CE level, repetition number, periodicity, and a backoff timer value.
Time-frequency resource configuration
Resource repetition configuration
Signal strength-based CE level classification
Available OCC configuration when OCC is used
Backoff timer configuration

More specifically, time-frequency resources may be configured in only the time domain, in only the frequency domain, or in both the time and frequency domains. Resource repetition may be an element applied to reduce a collision probability among terminals due to use of common resources. According to an exemplary embodiment of the present disclosure, time-frequency resources for CB-Msg3 may be configured as follows.
Time-domain resources: time-domain resources may include a periodicity and a starting time for PUSCH transmission occasions.
Frequency-domain resources: frequency-domain resources may include, in a case of eMTC, a combination list of a starting resource block (RB) and a length of continuously allocated RBs for CE mode A, and a combination list of a narrowband index and physical resource blocks (PRBs) in a narrowband for CE mode B. Frequency-domain resources, in a case of NB-IoT, may include a carrier index for a single tone, a resource unit (RU) number and a subcarrier set list, and a RU number and a subcarrier set list for multiple tones.
OCC resources
Repetition number
PDCCH resources

Shared resource configuration for CB-Msg3 may include the following resource types.
Time-domain resources for (N) PUSCH transmission occasions: periodicity may be configured in units of radio frames and may include a starting time (e.g. a starting subframe, a starting SFN).
Frequency-domain resources for (N) PUSCH transmission occasions: Frequency-domain resources, in a case of eMTC, may include a combination list of a starting RB and a length of continuously allocated RBs for CE mode A, and a combination list of a narrowband index and PRBs in a narrowband for CE mode B. Frequency-domain resources, in a case of NB-IoT, may include a carrier index for a single tone, a RU number and a subcarrier set list, and a RU number and a subcarrier set list for multiple tones.
OCC resources
Repetition number
(N) PDCCH resources

The time-frequency resource configuration may include a starting time (i.e. definition of the first transmission occasion of the resource group) and a periodicity (i.e. a time interval of transmission occasions within the group). The signal strength-based CE level classification may be an element required for efficient CB-Msg3 operation, such as whether to repeat resources and a number of resource repetitions in the terminal. The network may configure, for each CE level, a part or all of the resources, maximum transport block size, and repetition number, and may support efficient data transmission. By configuring such RSRP thresholds, the network may induce the terminal to select a resource with a CE level appropriate for signal strength at the terminal. The network may perform signal strength-based priority allocation in which each terminal selects different frequency and time resources according to the CE level. The network may dynamically adjust a resource allocation period by monitoring a collision state.

The network may complete CB-Msg3 resource configuration. The terminal may select CB-Msg3 transmission resources based on the following information. The terminal may select resources through one piece of information among the following information. Alternatively, the terminal may select resources by sequentially using the following information. In other words, the terminal may select an appropriate CE level based on signal strength on the basis of the resource group information provided in the SIB, and then may randomly select a resource within a resource group per CE level provided through the SIB. The terminal may maximize resource efficiency by utilizing the existing TBS and CE level configuration.
Resource group information provided in system information
Selection of an appropriate CE level based on a signal strength (e.g. RSRP, RSSI)
Random selection of a resource within a resource group per CE level

The terminal may complete resource selection for CB-Msg3 transmission. The terminal may transmit Msg3 in the selected resource. Msg3 may include an RRC early data request message and a data payload. The terminal may select a CE level based on RSRP. When a size of data to be transmitted is less than or equal to a configured TBS, the terminal may use the CB-Msg3 resource. When no resources exist in a specific CE level, the terminal may perform alternative access to the network through an RA procedure. When transmitting a replica message using DSA, the terminal may transmit the replica message within a specific time window. The terminal may reduce a collision probability and may increase reliability of data transmission by processing each replica independently.

The network may successfully receive one of repetitions or single transmission of CB-Msg3 transmitted by the terminal. The network may support the terminal in transmitting multiple replicas by using DSA. Through this, the network may increase resource sharing and a transmission success rate. To further increase resource sharing and a transmission success rate, the network may also consider multiplexing using OCC together with replicas through DSA. The network may fail to receive and a collision may occur.

In such a case, the network may determine whether restoration is possible through the replica message(s). When a collision occurs, the network may request retransmission to the terminal by using a backoff mechanism. In other words, when the network detects a collision, the network may indicate a backoff time to the terminal when responding with Msg4. The terminal may receive an indication of a backoff time from the network and may attempt retransmission by selecting a resource after the backoff time.

As described above, when transmitting a replica message, the network may dynamically reconfigure resources within a resource group to reduce a collision probability. The network may efficiently support a HARQ process while regarding the first Msg3 message and replicas as independent messages between terminals without considering combining at the physical layer level.

In this regard, to further improve resource sharing and a transmission success rate, the network may apply a multiplexing scheme using OCC together with replica transmission through DSA. Multiplexing using OCC may be a technique that enables simultaneous transmission from multiple terminals in identical time-frequency resources by using codes having orthogonality. Through this, multiple access in identical resources may be possible. The network may increase resource utilization efficiency. Specifically, OCC may minimize interference by using different orthogonal codes for respective terminals and may enable simultaneous transmission in identical resources.

In the case of CB-Msg3 using OCC, the network may designate an RSRP range for each CE level. This is to optimize performance of OCC, and the network may ensure that terminals using OCC have similar path loss states. Through this, reception powers at different terminals may be maintained at a similar level. A frequency offset error of different terminals may also be maintained within requirements. The terminal may trigger CB-Msg3 using OCC when measured RSRP is within a configured RSRP range for a selected CE level.

The network may treat the first transmission and a replica of CB-Msg3 as independent transmissions in terms of HARQ processing. Specifically, the network may operate an efficient HARQ process without performing combining at the physical layer level. This may allow the network to provide and process independent HARQ feedback for each transmission by treating replica messages as individual transmissions. This scheme may reduce complexity of HARQ processing and may enable efficient retransmission management when considering an RTT in the NTN environment longer than that of the TN environment.

The terminal may apply a HARQ retransmission optimization scheme considering the NTN environment. In the NTN environment, HARQ retransmission may have a greater impact than the existing TN environment due to an RTT longer than an RTT of the TN environment. The terminal may adjust a HARQ retransmission periodicity in consideration of characteristics of NTN and may set an optimal HARQ timer value by reflecting a delay time. HARQ retransmission may fail more than a certain number of times. The terminal may adjust a retransmission strategy by increasing a CE level or by applying backoff. Through this, the terminal may resolve a HARQ feedback delay issue in the NTN environment, may increase a transmission success rate, may prevent unnecessary HARQ retransmissions, and may reduce network load.

The network may apply a scheme for adjusting an acknowledgement (ACK)/negative ACK (NACK) delay time for HARQ feedback. In the NTN environment, a possibility of delay of ACK/NACK signals may be high. The network may apply a scheme of maintaining HARQ feedback for a time longer than an existing time. The network may adjust an ACK/NACK transmission interval and may receive feedback considering signal attenuation and propagation delay in the NTN environment. The network may configure automatic retransmission to be performed when an HARQ feedback is not received within a certain time. Through this, stable data transmission may be enabled even when ACK/NACK feedback is delayed in the NTN environment.

The network may apply a scheme of providing an option capable of deactivating HARQ-ACK. In the NTN environment, when HARQ-ACK is always required, an uplink signaling amount may increase and network load may increase. In a specific situation, the network may deactivate HARQ-ACK and may configure automatic retransmission when packets are missing more than a certain number of times. When HARQ-ACK is not required, the network may apply a 4-bit resource allocation scheme so that the network may deactivate HARQ-ACK. Through this, the uplink signaling amount in the NTN environment may be reduced, network load may be decreased, HARQ-ACK feedback may be minimized, and power consumption of the terminal may be reduced.

The network may apply a HARQ-ACK feedback transmission optimization scheme. In the NTN environment, a possibility of occurrence of signal attenuation and interference may be high in a process of transmitting ACK/NACK signals. The network may apply a multicast scheme so that one HARQ-ACK message may be used for multiple terminals when transmitting ACK/NACK. The network may transmit CB-Msg4 including a HARQ-ACK message as a single message. By doing so, the network may be configured such that the terminal does not need to monitor messages individually. Through this, the network may optimize HARQ-ACK feedback in the NTN environment and may improve response speed. When an individual terminal does not receive HARQ-ACK, the network may efficiently utilize resources by providing feedback to multiple terminals simultaneously.

The network may apply an RNTI reallocation scheme associated with a HARQ process. HARQ retransmission may be required in the NTN environment. In such a case, the network may apply a scheme that dynamically reallocates an RNTI instead of using the existing static RNTI allocation scheme. When retransmission is not performed after a certain time elapses after reception of a HARQ NACK, the network may allocate a new RNTI and may attempt retransmission. Through this, the network may increase reliability of HARQ retransmission in the NTN environment and may improve data transmission and reception efficiency. The network may support the terminal to rapidly change an RNTI when HARQ retransmission fails in the terminal so that retransmission may be performed on a new channel.

The network may apply a CB-MsgB window optimization scheme including HARQ-ACK and NACK. In the NTN environment, a possibility of delay of HARQ feedback may be high. The network may transmit HARQ-ACK and NACK information in a CB-MsgB window. The network may maintain the same scheme as the existing HARQ ACK/NACK scheme. The network may configure omission of HARQ-ACK transmission in certain conditions of the NTN environment. Through this, the network may efficiently transmit HARQ-ACK in the NTN environment and may increase feedback reception success rate. The network may minimize a signal monitoring burden of the terminal by including HARQ feedback within a CB-MsgB window.

The network may configure the terminal to implement a scheme of applying a variable repetition number for HARQ retransmission in the NTN environment. Signal attenuation and interference may be severe in the NTN environment. The network may configure a variable repetition number instead of fixing a HARQ retransmission number. The network may minimize an initial HARQ retransmission number and may apply a scheme of gradually increasing the repetition number when necessary. Through this, the network may reduce unnecessary HARQ retransmissions in the NTN environment and may reduce network load, and may reduce power consumption of the terminal by variably adjusting the repetition number.

The network may transmit Msg4 (response message) for successfully received Msg3. Msg4 may include the following information.
MAC CE for contention resolution
Terminal identification information (e.g. RNTI-based information)

The network may consider the following parameters when calculating an RNTI for CB-Msg3:
Time-domain resource: the time-domain resource may include an SFN index. According to an exemplary embodiment of the present disclosure, the network may compress a portion including the SFN index to avoid an excessively large RNTI value when calculating an RNTI for CB-Msg3. For example, the network may divide the SFN index by a minimum periodicity. Alternatively, the network may perform a modulo operation on the SFN index based on a length of a contention resolution window.
Frequency-domain resources: in the case of eMTC, the frequency-domain resource may include a starting PRB index. In the case of NB-IoT, the frequency-domain resource may include a subcarrier set index and a carrier index.
Code domain resource: the code domain resource may include an OCC index.

Msg4 may include one or more MAC sub-PDUs. Through this, the network may respond to multiple terminals. Each response may include a contention resolution identifier for a successfully decoded Msg3. However, due to a TB size limitation, Msg4 may include only one MAC sub-PDU for one MAC SDU. Additionally, the network may allocate a C-RNTI to the terminals for which a contention resolution identity is included in Msg4, so that the network can transmit RRC messages to those terminals thereafter.

The network may simultaneously transmit CB-Msg4 to multiple terminals. This may mean that when multiple terminals transmit CB-Msg3, the network may respond to the multiple terminals through a single CB-Msg4. This scheme may enable efficient use of network resources and may be particularly useful in the IoT NTN environment in which multiple terminals simultaneously transmit data. Detailed implementation methods may be various, and may significantly improve message transmission efficiency in the NTN environment.

The network may apply a scheme of configuring an RNTI of Msg4 based on the existing RA-RNTI calculation scheme in CB-Msg3 EDT. In the existing RACH procedure, the terminal may use an RA-RNTI for receiving Msg4 (e.g. response) and may map PRACH resources based on a specific equation. Similarly, in CB-Msg3 EDT, the network may configure an RNTI of Msg4 based on the RA-RNTI. Then, standardization may be simplified.

The network may allocate a C-RNTI to the terminal through Msg4 and may support subsequent scheduling. In the existing RACH procedure, the network may allocate a TC-RNTI to the terminal in Msg2 (RAR). In CB-Msg3 EDT, a Msg2 step may not exist. The network may need to allocate a C-RNTI directly in Msg4. The terminal may perform subsequent data transmission by using the C-RNTI of Msg4.

Subsequent downlink data may not exist in connected packet (CP)-based EDT and CB-Msg3 EDT. In such a case, the network may apply options for Msg4 optimization. In the existing EDT, the network may complete an EDT procedure by receiving an RRC early data complete message or an RRC connection release message after transmitting Msg4. The PUR scheme may achieve resource usage optimization by introducing L1/L2 ACK. In CB-Msg3 EDT, the network may need an optimized Msg4 delivery scheme to reduce unnecessary signaling load. In this regard, the network may consider two options.

The first option may be a scheme of transmitting an L1 ACK by using a terminal-dedicated RNTI. The second option may be a scheme of defining a new MAC CE including a contention resolution identifier and EDT termination information. The network may improve efficiency of Msg4 delivery through these options.

The network may apply a scheme of including contention resolution messages for multiple terminals in one Msg4 to efficiently transmit Msg4. In the existing EDT, the network may transmit Msg4 for each terminal. Accordingly, waste of PDSCH resources may occur. The network may transmit Msg4 including contention resolution messages for multiple terminals to the multiple terminals.

Multiple terminals may receive Msg4 including contention resolution messages for the multiple terminals. The network may reduce signaling load and may increase uplink processing capacity. The network may transmit Msg4 for the multiple terminals in a multicast scheme similar to the RAR scheme. The network may minimize common information elements included in Msg4, thereby reducing PDSCH resource usage when Msg4 includes responses for multiple terminals.

The network may include a contention resolution message for multiple terminals in Msg4. In such a case, the network may minimize common information elements and may reduce an overall message size. Through this, the network may use network resources more efficiently. This scheme may provide significant advantages in terms of resource efficiency in the NTN environment.

The terminal may transmit CB-Msg3 including an RRC early data request message. The following cases may occur.
Case 1: When matching of a UE contention resolution identifier succeeds, the terminal may terminate the RRC procedure. Case 1 may apply to a scenario where no downlink data exists.
Case 2: When matching of a UE contention resolution identifier succeeds, the terminal may stop a contention resolution window and may regard contention resolution as successful. The terminal may wait for subsequent RRC messages (e.g. RRC early data complete, RRC connection reject, RRC connection setup).
Case 3: The terminal may receive a UE contention resolution identifier and an RRC message together. In such a case, the terminal may stop a contention resolution window and may regard contention resolution as successful. The terminal may complete the RRC procedure based on the received RRC message.

In CB-Msg3 for a CP solution, the network may terminate a procedure early by using a UE contention resolution identifier. Also, in Msg4 of a CB-Msg3 procedure, the network may transmit a UE contention resolution identifier and an RRC message together. Alternatively, the network may transmit a UE contention resolution identifier and an RRC message separately in Msg4 of a CB-Msg3 procedure.

15 kHz SCS NB-IoT terminals and eMTC CE mode B terminals may require TA timing advance verification. The network may provide TA verification parameters to 15 kHz SCS NB-IoT terminals and eMTC CE mode B terminals through RRC dedicated signaling (e.g. RRC release message). These terminals may share resources configured in system information when TA is valid.

Similarly to an existing EDT procedure, the network may include first 48 bits of a common control channel (CCCH) service data unit (SDU) in Msg4 for contention resolution of CB-Msg3 EDT. Specifically, the network may include a UE contention resolution identifier in a downlink MAC PDU, and the terminal may receive the downlink MAC PDU including the UE contention resolution identifier through Msg4. The terminal may verify whether the received UE contention resolution identifier matches the first 48 bits of the CCCH SDU payload transmitted in Msg3.

The network may consider a multicast response to increase transmission efficiency of Msg4 and to reduce resource consumption when responding to Msg3 by using Msg4. In other words, the network may use an identical RNTI for multiple terminals when transmitting Msg4. The network may transmit a multicast response through a group RNTI for multicast so that the terminals that have successfully received replica messages within an identical resource group may receive the multicast response, thereby optimizing resource usage.

In this regard, the network may apply a scheme that supports multiple terminals in one Msg4 similarly to the existing RAR scheme. The network may save PDSCH resources and may reduce network load. The network may apply a PUR-like L1 ACK scheme. The network may introduce L1 ACK to optimize the Msg4 response scheme and may reduce unnecessary signaling load.

When the terminal declares contention resolution failure, the terminal may have a limit on a number of CB-Msg3 transmission attempts. When a contention resolution timer expires, the terminal may have a limit on a number of CB-Msg3 transmission attempts. When the limited number of transmission attempts is reached, the terminal may transition to a general four-step RACH-based procedure (e.g., RACH or EDT). The network may configure the terminal with such a limitation through system information.

The network may introduce a hierarchical RNTI scheme to efficiently manage multiple RNTIs for replica messages. In other words, the network may reduce network monitoring complexity by using a common RNTI for all replica messages within a specific group. The network may use an individual RNTI as an additional detailed RNTI for identifying successful Msg3 transmission of an individual terminal.

The network may apply a dynamic RNTI allocation scheme in the NTN environment. Propagation delay may be large in the NTN environment. The network may apply a dynamic RNTI allocation scheme instead of the existing static RNTI allocation scheme. When the terminal transmits CB-Msg3, the network may dynamically allocate an RNTI in real time based on received data. The network may prevent unnecessary collisions by applying an RNTI reuse and change strategy suitable for the NTN environment. Through this, the network may secure flexibility of RNTI allocation in the NTN environment, may improve network efficiency, and may reduce RNTI collisions between terminals to increase a Msg3 transmission success rate.

The network may apply a CE level-based RNTI allocation optimization scheme. The network may differentially allocate an RNTI according to a CE level in the NTN environment. Accordingly, the network may configure operation of terminals in an appropriate signal environment. When a CE level is low (i.e. when signal strength is high), the network may allocate an RNTI in the same manner as the existing manner. When a CE level is high (i.e. when signal attenuation is severe), the network may optimize an RNTI allocation scheme. Through this, the network may improve transmission stability with optimal RNTI allocation per CE level and may assign a terminal-specific RNTI considering long-distance communication in the NTN environment.

The network may apply a dynamic RNTI reallocation scheme considering NTN characteristics. In the NTN environment, a signal environment may change after RNTI allocation. The network may apply a scheme of reallocating an RNTI in real time. When the terminal does not receive Msg3 or Msg4 response for a specific time, the terminal may be configured to reallocate an RNTI so that switching to new resources may be possible. The network may solve a signal attenuation problem through RNTI reallocation in the NTN environment and may support operations of the terminal in a more stable transmission environment.

The network may apply a scheme of using a common RNTI and an individual RNTI in the NTN environment. In the NTN environment, the terminal may transmit multiple replicas. The network may determine whether to allocate different RNTIs for individual replicas. The network may determine whether to use one common RNTI for individual replicas. The network may apply a scheme of configuring transmission of Msg4 to multiple terminals simultaneously in NTN by using a single RNTI. When a common RNTI is used, the network may use network signaling resources efficiently. When an individual RNTI is used, reliability of individual data transmission of the terminal may increase.

The terminal may apply a scheme to start an individual PDCCH monitoring window for each replica in DSA. When a multi-window scheme is used, the terminal may reduce a possibility of performing unnecessary PDCCH monitoring and may increase a possibility of collision avoidance. Therefore, the network may configure the terminal to start an independent PDCCH monitoring window for each replica. The network may use a common RNTI for all replicas in DSA.

The terminal may transmit up to 4 replicas. The terminal may monitor an individual RNTI for each replica. In such a case, complexity may increase. When a common RNTI is used, the terminal may monitor only one RNTI. The terminal may reduce power consumption and complexity. The network may multiplex multiple Msg4 in one MAC PDU for transmission.

The terminal may determine success or failure of Msg3 transmission based on a MAC CE received in Msg4. When Msg3 transmission fails, the terminal may select a new resource after a backoff period and may retransmit Msg3 by using the selected resource. The terminal may monitor a specific time window to receive a network response after transmission of CB-Msg3. The terminal may configure one PDCCH monitoring window as a single window in a single transmission or in a replica transmission using DSA. When contention resolution fails, the terminal may perform retransmission by using a backoff mechanism similar to PRACH.

In other words, for CB-Msg3, the terminal may perform a retry after a backoff time similar to PRACH. This is a mechanism to prevent collisions, and the network may configure the terminal with a backoff time.

The network may configure the terminal so that a CE level-based differentiated backoff time application scheme is implemented. When a CE level is high (i.e. when signal attenuation is severe), the network may configure the terminal with a longer backoff time and may limit excessive retransmissions in the terminal. When a CE level is low (i.e. when signal strength is high), the network may adjust a shorter backoff time to enable rapid retransmission. The network may preconfigure optimal backoff times per CE level and may induce the terminal to avoid unnecessary collisions. Through this, the network may distribute network load through backoff adjustment according to CE levels, may prevent unnecessary retransmissions at high CE levels, and may maximize resource utilization.

The terminal may apply a retransmission scheme after increasing a CE level when multiple CB-Msg3 failures occur. The terminal may fail transmission of CB-Msg3 multiple times. The terminal may automatically move to a higher CE level and may perform retransmission. The network may detect CB-Msg3 failures exceeding a certain number of times. Then, the network may allocate a higher CE level so that the terminal may use stronger signals. The network may solve a signal attenuation problem through increase of a CE level and may improve a transmission success rate. The network may prevent a situation in which the terminal unnecessarily retries with low signal strength and may save network resources.

The network may configure the terminal so that a stepwise retransmission backoff fallback mechanism is implemented by applying a backoff timer in the terminal. The terminal may fail transmission of CB-Msg3. The terminal may run a random backoff timer and may perform retransmission after waiting for a certain time. The terminal may fail transmission of CB-Msg3 more than a certain number of times. The terminal may perform retransmission while gradually increasing a backoff time. When a number of retransmissions is finally exceeded, the network and the terminal may transition to a four-step PRACH procedure. Through this, the network may reduce network load by preventing excessive retries of the terminal, may gradually increase a backoff time, and may minimize collisions between terminals.

The network may configure the terminal so that an adaptive backoff application scheme considering the NTN environment is implemented in the terminal. In the NTN environment, transmission delay may occur due to an RTT longer than an RTT in the TN environment. The network may dynamically adjust a backoff time in consideration of the RTT value. The terminal may not receive an Msg4 response. The network may provide an optimal RTT-based backoff value to the terminal and may adjust a retransmission timing. Through this, the network may prevent unnecessary retransmission in the NTN environment, may reduce network load, and may reduce battery consumption of the terminal through the RTT-based optimized backoff configuration.

The network may apply a collision detection and retransmission optimization scheme based on Msg4. The terminal may fail to receive Msg4. In such a case, the terminal may not immediately retransmit in an identical CE level and may retransmit after applying a random backoff. When a collision is detected in Msg4, the network may dynamically adjust a backoff time and may adjust a transmission interval between terminals. Through this, the network may optimize a retransmission interval to prevent collisions between terminals when Msg4 reception fails, and may enable stable retransmission even when signal delay occurs in the NTN environment.

The network may apply a signal strength-based backoff adjustment scheme in the NTN environment. The network may apply a scheme of determining a backoff time based on an RSRP value measured by the terminal. When signal strength is high, the network may apply a short backoff. When signal strength is low, the network may apply a long backoff. In this manner, the network may prevent collisions between terminals. Through this, the network may improve a transmission success rate through signal strength-based optimized backoff and may control so that the terminal experiencing severe signal attenuation in the NTN environment does not perform unnecessary retransmission.

When a CB-Msg3 collision occurs, the network may configure the terminal so that a backoff mechanism similar to the PRACH scheme is applied. The network may configure the terminal to perform retransmission by applying a random backoff timer for collision avoidance. Regardless of whether the SA, DSA, or OCC2 approach is used, the network may support an identical backoff mechanism to maintain consistency. The network may distribute network load and may effectively reduce collisions through such a mechanism.

When CB-Msg3 EDT fails more than a certain number of times, the terminal may apply a scheme of transitioning to a four-step random access EDT. CB-Msg3 EDT may show high performance in a low-load environment. In a high-load environment, the existing RACH EDT may be more effective than CB-Msg3 EDT. Accordingly, when CB-Msg3 EDT failures accumulate, the network may configure the terminal to transition to a four-step random access. Through this, the network may improve network connection reliability.

The network may apply a scheme to support fallback to RRC connection setup after CB-Msg3 EDT. Specifically, the terminal may receive additional downlink data after CB-Msg3 EDT. For this, the terminal may require transitioning to an RRC connected state. When RRC connection is set up, the network may need to allocate a new C-RNTI to the terminal.

A CB-Msg3 RNTI may be derived from a PUSCH resource. In establishing RRC connection, the terminal may require a new C-RNTI. After CB-Msg3 transmission failure, the terminal may be able to fallback to a four-step RACH or PUR. The terminal may fail CB-Msg3 transmission multiple times. In such a situation, the network may support another access approach for the terminal. The network may ensure reliable communication in the NTN environment through the fallback mechanism.

Excessive CB-Msg3 transmission collisions may occur. The terminal may apply an approach for adjusting CB-Msg3 transmission collisions as a mechanism for preventing CB-Msg3 transmission collisions. For example, the network may utilize the existing RACH collision avoidance scheme and may reduce collision probability.

The network may configure the terminal with separate parameters for uplink transmission power control for CB-Msg3 EDT (e.g. p0-UE-NPUSCH and alpha α). In the CB-Msg3 EDT procedure, the network may configure the terminal to use identical parameters to the existing PUSCH power control scheme and may optimize uplink transmission power. The network may apply a scheme to increase uplink transmission power in the terminal in consideration of a number of CB-Msg3 failures. In the existing RACH scheme, the network may apply a scheme to increase uplink transmission power in the terminal according to a number of Msg3 retransmissions. In the CB-Msg3 procedure, the network may introduce a similar approach and may improve a transmission success rate.

The network may apply a scheme of preventing delay caused by unnecessary retransmission by configuring the terminal with a maximum CB-Msg3 EDT transmission attempt number. The network may prevent the terminal from retransmitting CB-Msg3 EDT without limitation and may minimize uplink delay. When a maximum transmission number is exceeded, the network may perform the existing RACH procedure and may support fallback so that uplink resources may be obtained. For example, CB-Msg3 EDT may fail more than a certain number of times. In such a case, the network may fallback to a four-step RACH and may use network resources efficiently.

In summary, main components of a CB-Msg3 transmission mechanism may be as follows.

First, with respect to replica transmission, the terminal may transmit Msg3 by replicating identical data in multiple time slots or frequency resources. The network may resolve collision by successfully receiving one of the replicated Msg3. Next, with respect to resource configuration, the network may configure appropriate resources per CE level and may support the terminal so that the terminal selects appropriate resources per CE level. In this case, resource groups may be defined in time, frequency, and code domains.

Next, with respect to a backoff mechanism, when Msg3 transmission fails, the terminal may retry transmission after a certain period by using a backoff timer. The network may dynamically configure a backoff time for the terminal. Next, with respect to contention resolution, contention may be resolved through Msg4. The terminal that has successfully transmitted Msg3 may proceed to a next procedure based on RNTI.

The network may additionally consider the following parameter configurations for CB-Msg3 transmission in consideration of the NTN communication environment having a long round-trip delay.
Adjustment of a time interval between replicas: configuration of replica transmission interval in consideration of differences in satellite delay, such as GEO and LEO
Limitation of number of replicas: limitation of number of replica messages per CE level to reduce network load
RTT-based timer configuration: appropriate increase of timer values in consideration of an RTT in the NTN environment longer than an RTT in the TN environment.

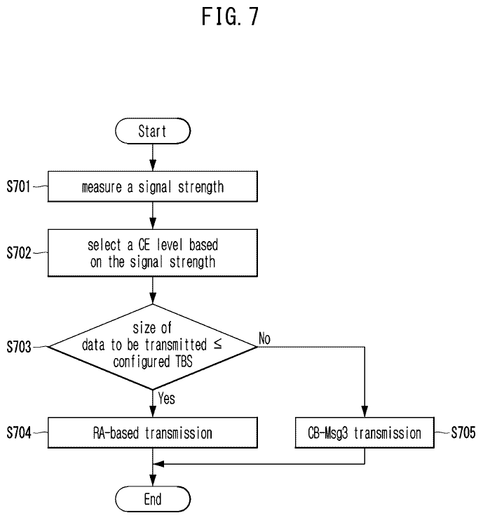

FIG. 7 is a flowchart illustrating exemplary embodiments of a method of transmitting message 3 of a terminal.

Referring to FIG. 7, a base station may transmit a reference signal to a terminal. The terminal may receive the reference signal, and may measure a signal strength of the received reference signal (S701). The terminal may select a CE level based on the measured signal strength (S702). Specifically, the terminal may select a CE level suitable to the terminal by using signal strength information such as RSRP or RSSI. The terminal may determine a size of data to be transmitted. In this document, ‘data to be transmitted’ means upper-layer data available to be transmitted and, for comparison, refers to the total upper-layer data included in the resulting MAC PDU. The ‘size of the data to be transmitted’ refers to the total upper-layer data included in the resulting MAC PDU, which is compared against the signalled/configured TBS. The terminal may determine whether the determined size of data to be transmitted is equal to or less than a preset transport block size (S703). When the size of data to be transmitted is equal to or less than the preset transport block size, the terminal may randomly select a resource within a resource group corresponding to the selected CE level. The terminal may transmit CB-Msg3 to the base station by using the selected resource (S704). The base station may receive CB-Msg3 from the terminal through the selected resource. When the size of data to be transmitted exceeds the preset transport block size, the terminal may attempt to access the base station through a random access procedure (S705).

When the size of data to be transmitted exceeds a predetermined transport block size, the terminal is configured to initiate CP transmission based on PUR and to transmit an RRCEarlyDataRequest to the base station.

When the size of data to be transmitted exceeds the predetermined transport block size, the terminal is configured to enter an RRC connection request procedure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, information on at least one resource for transmission of a message 3 (Msg3), the at least one resource being classified according to coverage enhancement (CE) levels;
determining a first CE level based on a received signal strength;
determining a target resource for transmission of the Msg3 in a resource corresponding to the determined first CE level among the at least one resource; and
transmitting the Msg3 to the base station using the determined target resource.

2. The method of claim 1, further comprising: transmitting, to the base station, a replica message identical to the Msg3 within a predetermined time window.

3. The method of claim 1, further comprising:
receiving, from the base station, a message 4 (Msg4) in response to the Msg3;
determining whether transmission of the Msg3 is successful based on the received Msg4; and
retransmitting the Msg3 based on determining that the transmission of the Msg3 fails.

4. The method of claim 3, wherein the determining of whether the transmission of the Msg3 is successful comprises:
acquiring a contention resolution identifier from the Msg4; and
based on whether the contention resolution identifier matches a portion of bits of a Common Control Channel (CCCH) Service Data Unit (SDU) transmitted in the Msg3, determining whether the transmission of the Msg3 is successful.

5. The method of claim 3, wherein the retransmitting of the Msg3 comprises:
reselecting a target resource after a backoff period; and
retransmitting the Msg3 using the reselected target resource.

6. The method of claim 1, wherein the determining of the first CE level comprises:
receiving a reference signal from the base station;
measuring the received signal strength of the reference signal; and
determining the first CE level based on the measured received signal strength.

7. The method of claim 1, wherein the determining of the target resource comprises:
determining a size of data to be transmitted;
determining whether the size of the data is equal to or less than a predetermined transport block size; and
determining the target resource based on determining that the size of the data is equal to or less than the predetermined transport block size.

8. The method of claim 1, further comprising:
determining a size of data to be transmitted;
determining whether the size of the data exceeds a predetermined transport block size; and
initiating a radio resource control (RRC) connection request procedure based on determining that the size of the data exceeds the predetermined transport block size.

9. The method of claim 1, wherein the information on the at least one resource includes, for each CE level, at least one of: information on resource(s), a number of repetitions, or a window.

10. A method of a base station, comprising:
configuring at least one resource for transmission of a message 3 (Msg3), the at least one resource being classified according to coverage enhancement (CE) levels;
transmitting, to a terminal, information on the at least one resource;
receiving a Msg3 from the terminal through a target resource selected within a resource determined according to a CE level for the terminal among the at least one resource; and
transmitting, to the terminal, a message 4 (Msg4) in response to the Msg3.

11. The method of claim 10, wherein the transmitting of the information on the at least one resource to the terminal comprises:
generating a system information block including the information on the at least one resource; and
broadcasting the system information block toward the terminal.

12. The method of claim 10, wherein the Msg4 includes a contention resolution identity configured to allow the terminal to identify the Msg4 as a response to the Msg3.

13. The method of claim 10, wherein the Msg4 includes at least one of: a first radio network temporary identifier (RNTI) for identifying Msg3 transmission of an individual terminal, or a second RNTI for identifying the terminal.

14. The method of claim 13, wherein the first RNTI is generated based on a result of performing a modulo operation on a system frame number (SFN) with respect to a length of a contention resolution window.

15. A terminal comprising at least one processor, wherein the at least one processor causes the terminal to perform:
receiving, from a base station, information on at least one resource for transmission of a message 3 (Msg3), the at least one resource being classified according to coverage enhancement (CE) levels;
determining a first CE level based on a received signal strength;
determining a target resource for transmission of the Msg3 in a resource corresponding to the determined first CE level among the at least one resource; and
transmitting the Msg3 to the base station using the determined target resource.

16. The terminal of claim 15, wherein the at least one processor further causes the terminal to perform: transmitting, to the base station, a replica message identical to the Msg3 within a predetermined time window.

17. The terminal of claim 15, wherein the at least one processor further causes the terminal to perform:
receiving, from the base station, a message 4 (Msg4) in response to the Msg3;
determining whether transmission of the Msg3 is successful based on the received Msg4; and
retransmitting the Msg3 based on determining that the transmission of the Msg3 fails.

18. The terminal of claim 15, wherein in the determining of the first CE level, the at least one processor causes the terminal to perform:
receiving a reference signal from the base station;
measuring the received signal strength of the reference signal; and
determining the first CE level based on the measured received signal strength.

19. The terminal of claim 15, wherein in the determining of the target resource, the at least one processor causes the terminal to perform:
determining a size of data to be transmitted;
determining whether the size of the data is equal to or less than a predetermined transport block size; and
determining the target resource based on determining that the size of the data is equal to or less than the predetermined transport block size.

20. The terminal of claim 15, wherein the at least one processor further causes the terminal to perform:
determining a size of data to be transmitted;
determining whether the size of the data exceeds a predetermined transport block size; and
initiating a radio resource control (RRC) connection request procedure based on determining that the size of the data exceeds the predetermined transport block size.
